(19) United States
(12) Patent Application Publication
(10) Pub. No.: US 2012/0176007 A1
(43) Pub. Date: Jul. 12, 2012

(54) ELECTRIC MACHINE DEVICE, ACTUATOR USING THE SAME, MOTOR, ROBOT, AND ROBOT HAND

(75) Inventor: Kesatoshi TAKEUCHI, Shiojiri (JP)

(73) Assignee: SEIKO EPSON CORPORATION, Tokyo (JP)

(21) Appl. No.: 13/347,079

(22) Filed: Jan. 10, 2012

(30) Foreign Application Priority Data
Jan. 11, 2011 (JP) 2011-002759

(51) Int. Cl. B25J 17/00; H02K 11/00; H02K 7/116; F16H 1/28; B25J 15/02

(52) U.S. Cl. 310/68 B; 475/149; 74/490.05; 294/198; 310/83

(57) ABSTRACT

An electric machine device includes: a rotor including a rotor magnet arranged along the outer circumference of a center shaft; a stator arranged on the outer circumference of the rotor; a rotating mechanism coupled to the rotor and used for transmission of rotation driving force; and a load connecting section that connects the rotating mechanism and a load. In the rotor, a housing space that is opened on one side in an axis direction of the center shaft and houses at least a part of the rotating mechanism is formed between the center shaft and the rotor magnet. The rotating mechanism includes: an input section connected to or formed integrally with the rotor; a fixed section connected to or formed integrally with the stator; and an output section connected to or formed integrally with the load connecting section. The rotting mechanism functions as a speed-increasing gear or a reduction gear.

### BACKGROUND

1. Technical Field

The present invention relates to an electric machine device.

2. Related Art

Usually, a motor is used as a power source for driving a joint region of a robot (JP-A-2008-159847, etc.). In general, the motor is used while being connected to a rotating mechanism such as a reduction gear that adjusts the rotating speed and the torque of the motor. In order to reduce the size of the robot, an electric machine device that includes a motor and a rotating mechanism connected to the motor and converts electric power and motive power is desirably configured compactly. Under the actual situation in the past, sufficient ingenuity has not been exercised in response to such a request.

### SUMMARY

An advantage of some aspects of the invention is to provide a technique for reducing the size of an electric machine device.

### Application Example 1

This application example of the invention is directed to an electric machine device including: a center shaft; a rotor including a rotor magnet arranged along the outer circumference of the center shaft; a stator arranged on the outer circumference of the rotor; a rotating mechanism coupled to the rotor and used for transmission of rotation driving force; and a load connecting section that connects the rotating mechanism and a load. In the rotor, a housing space that is opened at least on one side in an axis direction of the center shaft and houses at least a part of the rotating mechanism is formed between the center shaft and the rotor magnet. The rotating mechanism includes: an input section connected to or formed integrally with the rotor; a fixed section connected to or formed integrally with the stator; and an output section connected to or formed integrally with the load connecting section. The rotting mechanism functions as a speed-increasing gear or a reduction gear.

With the electric machine device, at least a part of the rotating mechanism is housed in the housing space of the rotor. The rotor that generates rotation and the rotating mechanism that transmits the rotation are integrally formed. Therefore, the electric machine device is reduced in size.

### Application Example 2

This application example of the invention is directed to the electric machine device of the above application example, wherein the center shaft includes a through-hole extending in the axis direction of the center shaft. A conductive wire that transmits electricity for controlling the rotation of the rotor is inserted through the through-hole.

With the electric machine device, since the conductive wire for controlling the rotation of the rotor is inserted through the inside of the center shaft, exposure of the conductive wire to the outside is suppressed and protection properties and arrangement properties of the conductive wire are improved. Design properties of devices mounted on the electric machine device are suppressed from being deteriorated by the exposure of the conductive wire.

### Application Example 3

This application example of the invention is directed to the electric machine device of Application Example 1 or 2, wherein the rotating mechanism includes a planet gear including: a sun gear arranged in the central part of the rotating mechanism; an outer gear arranged in the outer circumferential part of the rotating mechanism; a planetary gear arranged between the sun gear and the outer gear; and a planetary carrier to which the planetary gear is connected. In the rotating mechanism, one of the sun gear, the outer gear, and the planetary carrier is the input section, one of the remaining two is the fixed section, and the remaining one is the output section.

With the electric machine device, since the planet gear and the rotor are integrally formed, the electric machine device is reduced in size.

### Application Example 4

This application example of the invention is directed to the electric machine device of Application Example 1 or 2, wherein the rotating mechanism includes a harmonic drive mechanism (“harmonic drive” is a registered trademark) including: a wave generator arranged in the central part of the rotating mechanism; a circular spline arranged in the outer peripheral part of the rotating mechanism; and a flex spline arranged between the wave generator and the circular spline. In the rotating mechanism, one of the wave generator, the circular spline, and the flex spline is the input section, one of the remaining two is the fixed section, and the remaining one is the output section.

With the electric machine device, since the harmonic drive (registered trademark) mechanism and the rotor are integrally formed, the electric machine device is reduced in size.

### Application Example 5

This application example of the invention is directed to the electric machine device of Application Example 1 or 2, wherein the rotating mechanism includes a cycloidal mechanism including: a curved plate having an epitrochoid parallel curve shape at the outer edge and having a first hole formed in the center and plural second holes formed around the first hole; outer pins arranged in contact with the epitrochoid parallel curve of the curved plate; inner pins arranged in the second holes; and an eccentric body arranged in the first hole. One of the eccentric body, the outer pins, and the inner pins is the input section, one of the remaining two is the fixed section, and the remaining one is the output section.

With the electric machine device, since the cycloidal mechanism and the rotor are integrally formed, the electric machine device is reduced in size.

### Application Example 6

This application example of the invention is directed to the electric machine device of any of Application Examples 1 to 5, which further includes an encoder formed integrally with the rotor.

With the electric machine device, since the encoder and the rotor are integrally formed, the electric machine device is reduced in size.

### Application Example 7

This application example of the invention is directed to an actuator including the electric machine device of any of Application Examples 1 to 6.

With the actuator, since the electric machine device reduced in size is used as a driving source, it is possible to configure the actuator more compactly.

### Application Example 8

This application example of the invention is directed to a motor including: a center shaft; a rotor including a rotor magnet arranged along the outer circumference of the center shaft; a stator arranged on the outer circumference of the rotor; a rotating mechanism coupled to the rotor and used for transmission of rotation driving force; and a load connecting section that connects the rotating mechanism and a load. A housing space that is opened at least on one side in an axis direction of the center shaft and houses at least a part of the rotating mechanism coupled to the rotor and used for transmission of the rotation driving force is formed between the center shaft and the rotor magnet. The rotating mechanism includes: an input section connected to or formed integrally with the rotor; a fixed section connected to or formed integrally with the stator; and an output section connected to or formed integrally with the load connecting section. The rotating mechanism functions as a speed-increasing gear or a reduction gear.

With the motor, it is possible to integrate and configure the rotor and the rotating mechanism more compactly.

### Application Example 9

This application example of the invention is directed to a robot including: a base; and a driving section for moving the base. The driving section includes the electric machine device of any of Application Examples 1 to 6.

### Application Example 10

This application example of the invention is directed to a robot including: a base; a moving section that moves relatively to the base; and a driving section that moves the moving section with respect to the base. The driving section includes the electric machine device of any of Application Examples 1 to 6.

### Application Example 11

This application example of the invention is directed to a robot hand including: a base, a gripping section that is arranged on the base and grips an object; and a driving section that drives the gripping section and causes the gripping section to grip the object. The driving section includes the actuator of Application Example 7.

The invention can be implemented in various forms. For example, the invention can be implemented in forms including electric machine devices such as a motor and an electric power generating device and an actuator, a robot, a robot arm, and a moving body using the electric machine devices.

### BRIEF DESCRIPTION OF THE DRAWINGS

The invention will be described with reference to the accompanying drawings, wherein like numbers reference like elements.

FIGS. 1A and 1B are schematic diagrams showing the configuration of a robot arm in a first embodiment.

FIGS. 2A and 2B are schematic diagrams showing the configuration of a robot arm as a reference example.

FIG. 3 is a schematic sectional view showing an internal configuration of a power generating device according to the first embodiment.

FIG. 4 is a schematic disassembled sectional view showing the internal configuration of the power generating device according to the first embodiment.

FIG. 5 is a schematic diagram for explaining a mechanism for transmitting rotation driving force on the inside of the power generating device according to the first embodiment.

FIGS. 6A and 6B are schematic diagrams showing the configuration of a power generating device as other configuration examples according to the first embodiment.

FIGS. 7A and 7B are schematic diagrams showing the configuration of a power generating device as still other configuration examples according to the first embodiment.

FIGS. 8A and 8B are schematic diagrams showing the configuration of a power generating device as still other configuration examples according to the first embodiment.

FIG. 9 is a schematic sectional view showing an internal configuration of a power generating device according to a second embodiment.

FIG. 10 is a schematic disassembled sectional view showing the internal configuration of the power generating device according to the second embodiment.

FIGS. 11A and 11B are schematic diagrams for explaining a mechanism for transmitting rotation driving force in two-stage planet gears of the power generating device according to the second embodiment.

FIG. 12 is a schematic sectional view showing an internal configuration of a power generating device according to a third embodiment.

FIG. 13 is a schematic disassembled sectional view showing the internal configuration of the power generating device according to the third embodiment.

FIG. 14 is a schematic diagram for explaining a mechanism for transmitting rotation driving force on the inside of the power generating device according to the third embodiment.

FIG. 15 is a schematic sectional view showing an internal configuration of a power generating device according to a fourth embodiment.

FIG. 16 is a schematic disassembled sectional view showing the internal configuration of the power generating device according to the fourth embodiment.

FIG. 17 is a schematic diagram for explaining a mechanism for transmitting rotation driving force on the inside of the power generating device according to the fourth embodiment.

FIG. 18 is a schematic sectional view showing the configuration of a power generating device according to a fifth embodiment.

FIGS. 19A to 19C are schematic diagrams illustrating types of rotating shafts attached to the power generating device according to the fifth embodiment.

FIG. 20 is a schematic sectional view showing an internal configuration of a power generating device 100E according to a sixth embodiment.

FIG. 21 is a schematic disassembled sectional view showing components of the power generating device 100E in a disassembled state.

FIG. 22 is an explanatory diagram schematically showing a cycloidal mechanism.

FIG. 23 is a schematic diagram showing the configuration of a power generating device 100F according to a modification of the sixth embodiment.

FIG. 24 is a schematic diagram showing the configuration of a power generating device 100G according to a seventh embodiment.

FIGS. 25A to 25D are explanatory diagrams showing the configurations of a permanent magnet and an electromagnetic coil group.

FIG. 26 is a schematic diagram showing the configuration of a power generating device 100H according to an eighth embodiment.

FIG. 27 is an explanatory diagram showing an example of the configuration of an encoder.

FIG. 28 is an explanatory diagram showing a modification of the configuration of the encoder.

### DESCRIPTION OF EXEMPLARY EMBODIMENTS

### A. First Embodiment

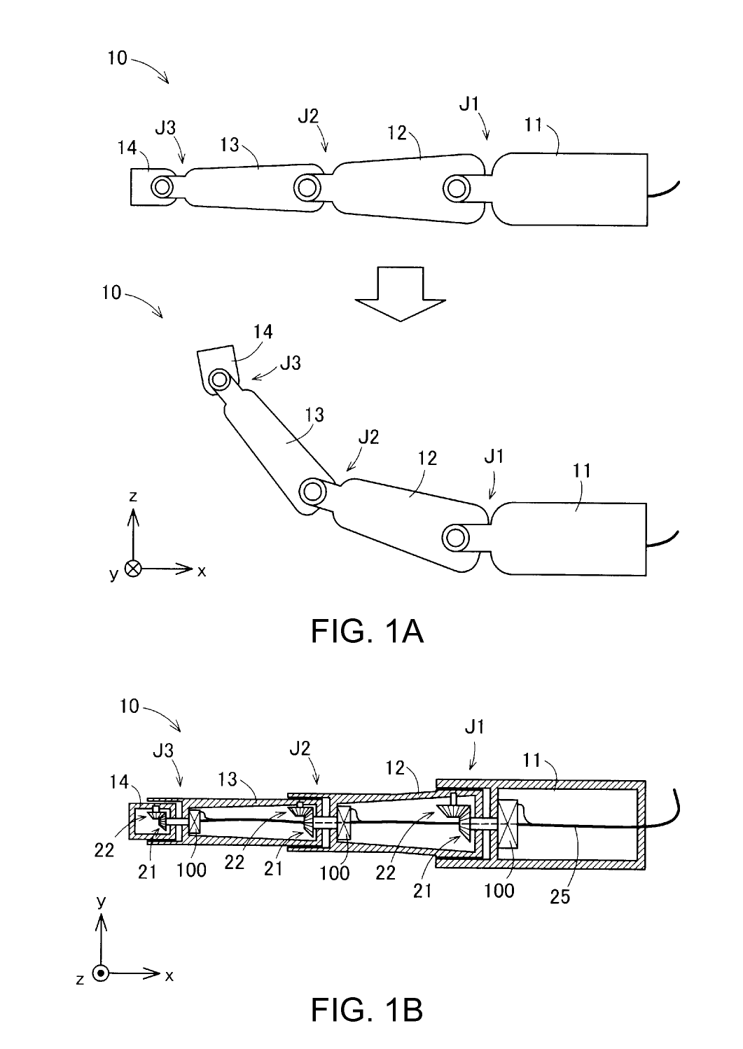

FIGS. 1A and 1B are schematic diagrams showing the configuration of a robot arm 10 (also referred to as “robot hand”) according to an embodiment of the invention. FIG. 1A is a schematic diagram showing a deformation form of the robot arm 10. The robot arm 10 before the deformation and the robot arm 10 after the deformation are shown. In FIG. 1A, three-dimensional arrows x, y, and z orthogonal to one another are shown.

The robot arm 10 includes four base sections 11 to 14. The four base sections 11 to 14 are coupled in series to one another via first to third joint sections J1 to J3. In the following explanation, in the robot arm 10, the first base section 11 side is referred to as “rear end side” and the fourth base section 14 side is referred to as “front end side”.

Coupling angles of the base sections 11 to 14 change according to pivoting in the joint sections J1 to J3. The robot arm 10 as a whole is deformed into a curved form. In FIG. 1A, as a form after the deformation of the robot arm 10, a state in which the robot arm 10 is curved to the upper side on the paper surface is shown.

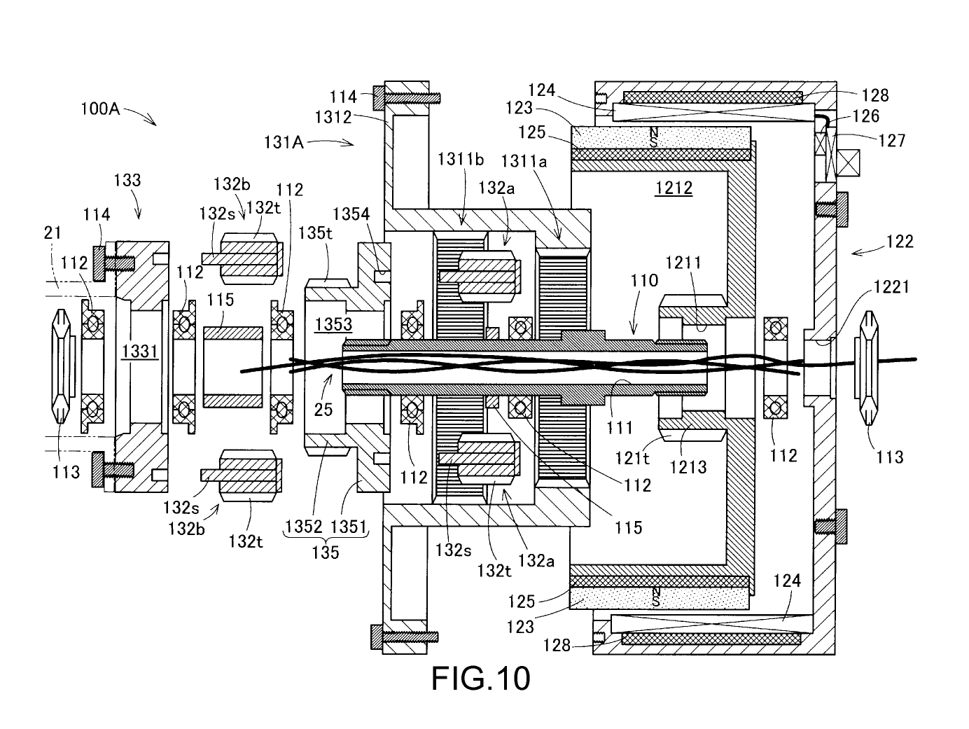

FIG. 1B is a schematic sectional view showing an internal configuration of the robot arm 10. In FIG. 10B, the three-dimensional arrows x, y, and z are shown to correspond to FIG. 1A. Each of the base sections 11 to 14 is hollow inside. A power generating device 100, which is a power source for each of the joint sections J1 to J3, and two bevel gears 21 and 22 to which driving force from the power generating device 100 is transmitted are housed in the base section. The configuration of the first joint section J1 that couples the first and second base sections 11 and 12 is explained below. The configuration of the second joint section J2 that couples the second and third base sections 12 and 13 and the configuration of the third joint section J3 that couples the third and fourth base sections 13 and 14 are the same as the configuration of the first joint section J1. Therefore, explanation of the configurations is omitted.

The power generating device 100 includes a motor that generates rotation driving force using electromagnetic force. A detailed internal configuration of the power generating device 100 is explained later. The power generating device 100 is arranged on the front end side of the first base section 11 and connected to a rotating shaft of the first bevel gear 21. The first bevel gear 21 is arranged such that the rotating shaft thereof pierces through a boundary between the first and second base sections 11 and 12. A gear section provided at the distal end of the rotating shaft is arranged in the second base section 12.

The second bevel gear 22 is fixedly attached to the inner wall surface of the second base section 12 on the rear end side of the second base section 12 such that a gear section of the second bevel gear 22 is coupled to the gear section of the first bevel gear 21. The first bevel gear 21 is rotated by the rotation driving force transmitted from the power generating device 100. According to the rotation of the first bevel gear 21, the second bevel gear 22 rotates and the second base section 12 rotates.

A conductive wire bundle 25, which is a bundle of conductive wires for transmitting electric power and a control signal to the power generating device 100, is inserted through the inside of the robot arm 10. Specifically, the conductive wire bundle 25 is inserted through the inside of the first base section 11 from the rear end side. A part of the conductive wires of the conductive wire bundle 25 branch and are connected to a connecting section of the power generating device 100 in the first base section 11. The remaining conductive wire bundle 25 extends to the second base section 12 through a through-hole (explained later) that pierces through the center of the power generating device 100 and a through-hole (not shown) that pierces through the center shaft of the first bevel gear 21.

The conductive wire bundle 25 is disposed in the same manner in the second base section 12. Specifically, a part of the conductive wire bundle 25 inserted through the inside of the second base section 12 is connected to the power generating device 100. The remaining conductive wire bundle 25 extends to the third base section 13 through the inside of the power generating device 100 and the first bevel gear 21. The conductive wire bundle 25 inserted through the third base section 13 is connected to the power generating device 100.

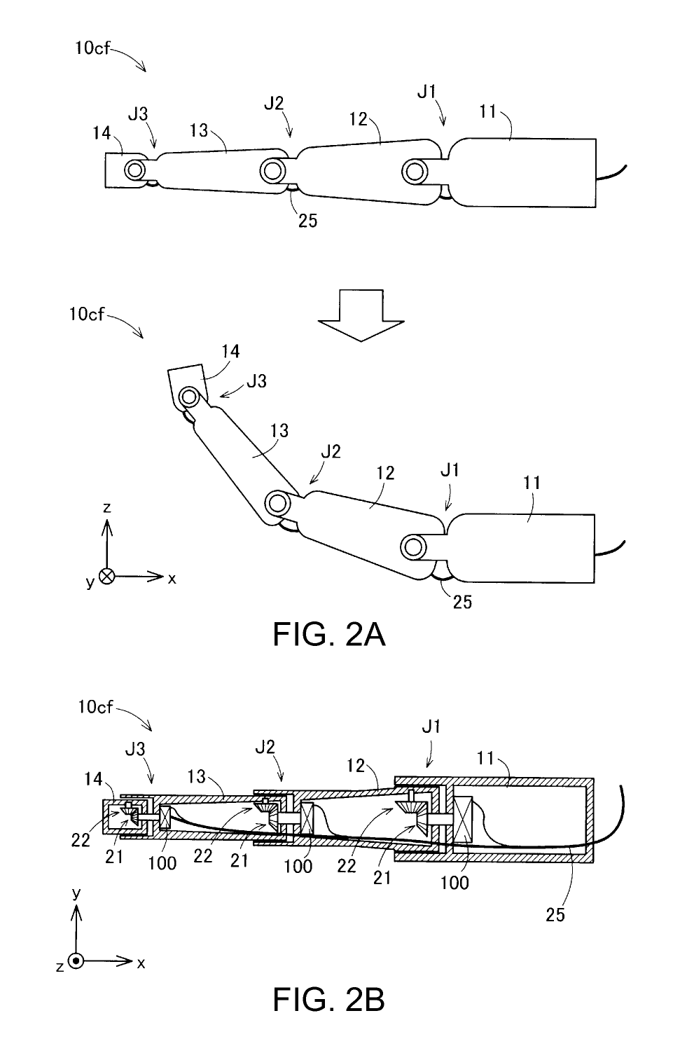

FIGS. 2A and 2B are schematic diagrams showing a robot arm 10cf as a reference example of this embodiment. FIGS. 2A and 2B are substantially the same as FIGS. 1A and 1B except that the conductive wire bundle 25 is wired on the outside of the power generating device 100 and the first bevel gear 21.

In the robot arm 10cf of the reference example, the conductive wire bundle 25 is exposed to the outside in each of the joint sections J1 to J3. Therefore, according to deformation of the robot arm 10cf, it is likely that the conductive wire bundle 25 is, for example, caught by the base sections 11 to 14 and deteriorated in the joint sections J1 to J3. Since the conductive wire bundle 25 is exposed to the outside, it is likely that design properties of the robot arm 10cf are deteriorated. However, in the robot arm 10 according to this embodiment, since the conductive wire bundle 25 is not exposed to the outside, occurrence of such a deficiency is suppressed.

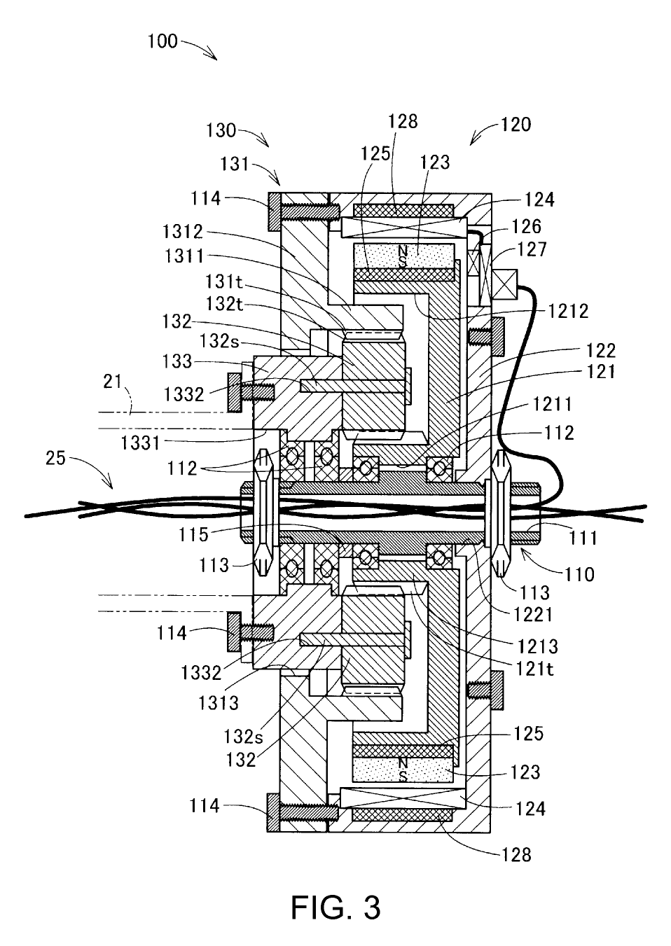

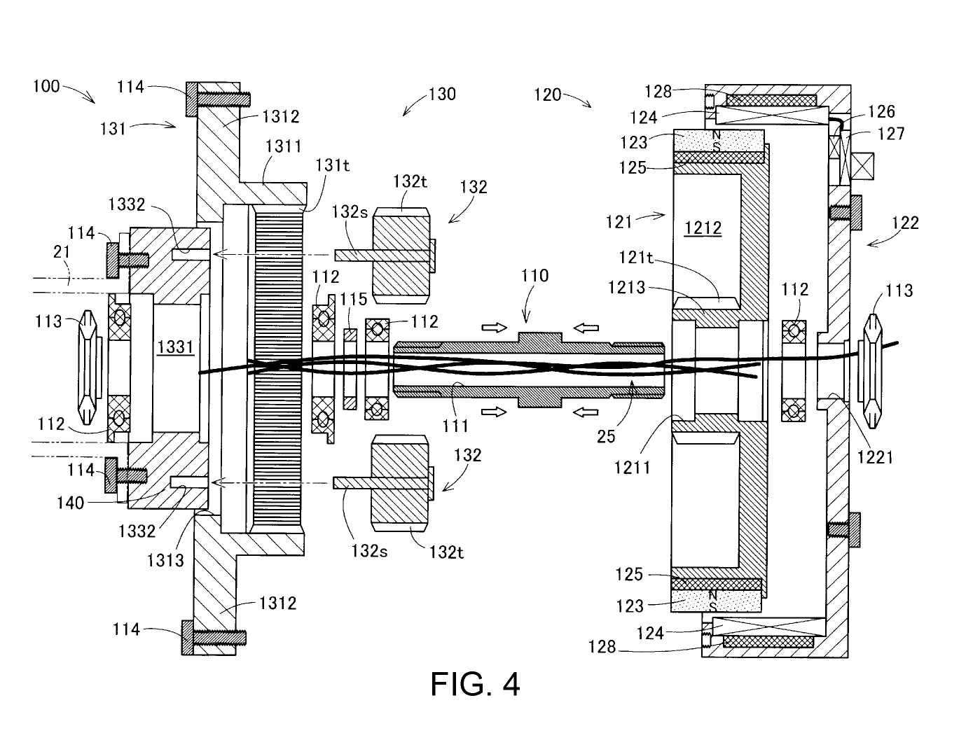

FIG. 3 is a schematic sectional view showing an internal configuration of the power generating device 100. FIG. 4 is a schematic disassembled sectional view showing components of the power generating device 100 in a disassembled state. In FIGS. 3 and 4, the rotating shaft of the first bevel gear 21 connected to the power generating device 100 is indicated by a broken line. The power generating device 100 includes a center shaft 110, a motor section 120, and a rotating mechanism section 130.

As explained later, the motor section 120 and the rotating mechanism section 130 are arranged to fit in and integrated with each other. The center shaft 110 is arranged to pierce through the center of the motor section 120 and the rotating mechanism section 130 integrated with each other. The center shaft 110 has a through-hole 111 extending in the axis direction. The conductive wire bundle 25 is inserted through the through-hole 111.

The motor section 120 includes a rotor 121 and a casing 122. As explained below, the motor section 120 has a configuration of a radial gap type. A body section of the rotor 121 has a substantially disc shape. A permanent magnet 123 is arrayed in a cylindrical shape on the outer circumferential surface of the sidewall of the body section. The direction of a magnetic flux of the permanent magnet 123 is a radial direction. A magnet back yoke 125 for improving magnetic force efficiency is arranged on a surface on the rear side of the permanent magnet 123 (a surface on the sidewall side of the rotor 121).

The rotor 121 has, in the center thereof, a through-hole 1211 for inserting through the center shaft 110. Bearing sections 112 for allowing the rotor 121 to rotate around the center shaft 110 are arranged between the inner wall surface of the through-hole 1211 and the outer circumferential surface of the center shaft 110. The bearing sections 112 can include, for example, ball bearings.

On a surface on a side opposed to the rotating mechanism section 130 of the rotor 121, a recess 1212 formed as a substantially annular groove around the through-hole 1211 is provided. Gear teeth 121t are formed on a wall surface on the outer side of a substantially cylindrical partition wall 1213 that partitions the through-hole 1211 and the recess 1212. The partition wall 1213 having the gear teeth 121t provided in the center of the rotor 121 is hereinafter referred to as “rotor gear 1213”. As explained later, the rotor gear 1213 in this embodiment functions as a sun gear of a planet gear.

The casing 122 is a substantially cylindrical hollow receptor, a surface of which on a side opposed to the rotating mechanism section 130 is opened. The casing 122 houses the rotor 121. The casing 122 may be formed of a resin material such as carbon fiber reinforced plastics (CFRP). This makes it possible to reduce the weight of the power generating device 100.

A through-hole 1221 for inserting through the center shaft 110 is formed in the center of the bottom surface of the casing 122. The center shaft 110 and the casing 122 are fixedly attached to each other. A bearing ring 113 for improving retaining properties of the center shaft 110 is attached in a fitting manner on the outer side of the casing 122.

On the inner circumferential surface of the casing 122, an electromagnetic coil 124 is arrayed in a cylindrical shape to be opposed to the permanent magnet 123 of the rotor 121 while having a space between the electromagnetic coil 124 and the permanent magnet 123. Specifically, in the motor section 120, the electromagnetic coil 124 functions as a stator and rotates the rotor 121 around the center shaft 110. A coil back yoke 128 for improving magnetic force efficiency is arranged between the electromagnetic coil 124 and the casing 122.

On the bottom surface of the casing 122, a position detecting section 126 that detects the position of the permanent magnet 123 and a rotation control circuit 127 for controlling the rotation of the rotor 121 are provided. The position detecting section 126 is formed of, for example, a Hall element and arranged to correspond to a position on a circulating track of the permanent magnet 123. The position detecting section 126 is connected to the rotation control circuit 127 via a signal line.

The conductive line branching from the conductive wire bundle 25 is connected to the rotation control circuit 127. The rotation control circuit 127 is electrically connected to the electromagnetic coil 124. The rotation control circuit 127 transmits a detection signal, which is output by the position detecting section 126, to a control section (not shown) that controls driving of the power generating device 100. The rotation control circuit 127 supplies electric power to the electromagnetic coil 124, causes the electromagnetic coil 124 to generate a magnetic field, and rotates the rotor 121 according to a control signal from the control section.

The rotating mechanism section 130 configures a planet gear in conjunction with the rotor gear 1213 of the rotor 121 and functions as a reduction gear. The rotating mechanism section 130 includes a gear fixing section 131, three planetary gears 132, and a load connecting section 133. In FIGS. 3 and 4, for convenience of illustration, only two planetary gears 132 are shown.

The gear fixing section 131 includes an outer gear 1311, which is a substantially annular gear, provided with gear teeth 131t on the inner wall surface thereof and a brim section 1312 projecting to the outer circumference of the outer gear 1311. The brim section 1312 and a sidewall end face of the casing 122 of the motor section 120 are fastened by a fixing bolt 114, whereby the gear fixing section 131 is fixedly attached to the motor section 120.

The outer gear 1311 of the gear fixing section 131 is housed in the recess 1212 of the rotor 121. The three planetary gears 132 are arranged at substantially equal intervals along the outer circumference of the rotor gear 1213 between the inner circumferential surface of the outer gear 1311 and the outer circumferential surface of the rotor gear 1213. Gear teeth 132t of the planetary gears 132, the gear teeth 131t of the outer gear 1311, and the gear teeth 121t of the rotor gear 1213 mesh with one another, whereby the three kinds of gears 1213, 132, and 1311 are coupled.

The load connecting section 133 is a substantially cylindrical member functioning as a planetary carrier. A through-hole 1331 through which the center shaft 110 is inserted is provided in the center of the bottom surface of the load connecting section 133. The bearing sections 112 for allowing the load connecting section 133 to rotate around the center shaft 110 are arranged between the inner wall surface of the through-hole 1331 and the outer circumferential surface of the center shaft 110. A spacer 115 is arranged between the bearing section 112 attached to the load connecting section 133 and the bearing section 112 attached to the rotor 121.

A substantially circular opening section 1313 communicating with an inner circumferential space of the outer gear 1311 is formed in the central part of the gear fixing section 131. The load connecting section 133 is arranged in the opening section 1313. In the bottom surface on the motor section 120 side (the right side on the paper surface in FIGS. 3 and 4) of the load connecting section 133, a shaft hole 1332 for rotatably retaining a rotating shaft 132s of the planetary gear 132 housed in the recess 1212 of the rotor 121 is formed.

The bearing ring 113 for improving retaining properties of the center shaft 110 is attached in a fitting manner to the bottom surface on the outer side (the left side on the paper surface in FIGS. 3 and 4) of the load connecting section 133. A rotating shaft of the first bevel gear 21 is fixed to the bottom surface on the outer side of the load connecting section 133 by the fixing bolt 114.

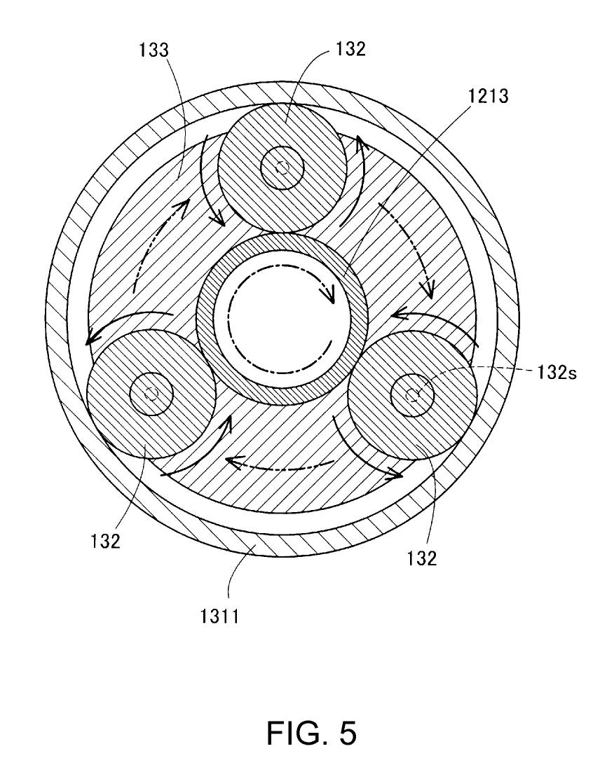

FIG. 5 is a schematic diagram for explaining a mechanism for transmitting rotation driving force on the inside of the power generating device 100. In FIG. 5, the rotor gear 1213, the three planetary gears 132, the outer gear 1311, and the load connecting section 133 of the power generating device 100 viewed along the axis direction of the center shaft 110 are schematically shown. In FIG. 5, for convenience of illustration, the gear teeth of the gears are not shown.

In the power generating device 100, it is assumed that the rotor gear 1213, which is the sun gear, rotates in a direction indicated by an arrow of an alternate long and short dash line according to the rotation of the rotor 121. As explained above, since the outer gear 1311 is arranged to be fixed, the planetary gears 132 circulatingly move around the rotor gear 1213 in a direction indicated by an arrow of an alternate long and two short dashes line (also referred to as “revolve”) while rotating in a direction indicated by a solid line arrow around the rotating shafts 132s of the planetary gears 132 (also referred to as “auto-rotate”) according to the rotation of the rotor gear 1213. According to the circulating movement of the planetary gears 132, the load connecting section 133 rotates and the first bevel gear 21 (FIGS. 1A and 1B) connected to the load connecting section 133 rotates.

In a usual motor, in order to improve responsiveness of the motor, it is desirable to reduce the diameter of a rotor, reduce inertia of the motor (motor inertia), and improve an inertia characteristic. On the other hand, in the motor section 120 in this embodiment, the diameter of the rotor 121 is expanded to a degree enough for housing the rotating mechanism section 130 and the motor inertia is increased. However, as in this embodiment, the inventor of the present invention found that, even when the rotor 121 is increased in diameter and the motor inertia is increased, deterioration in transient responsiveness to the control of the power generating device 100 is suppressed. A reason for this is as explained below.

In the power generating device 100 according to this embodiment, according to the increase in the diameter of the rotor 121, torque generated in the motor section 120 is increased. Torque transmitted to the rotating mechanism section 130 is increased during the start of the rotation of the rotor 121 and during switching of the rotating direction of the rotor 121. Therefore, in the power generating device 100, it is possible to cause the rotating mechanism section 130 to quickly follow a change in the rotation of the motor section 120. Deterioration in the transient responsiveness of the power generating device 100 is suppressed. In the power generating device 100, deterioration in an inertia characteristic in the motor section 120 is compensated by the improvement of a torque characteristic involved in the increase in the diameter of the rotor 121.

As explained above, in the power generating device 100 according to this embodiment, the sun gear is integrally provided in the rotor 121 and the planetary gears 132 and the outer gear 1311 are housed in the recess 1212 provided in the rotor 121. In other words, the power generating device 100 has a configuration in which the motor and the planet gear, which is the reduction gear, are compactly integrated. It is possible to reduce the size and the weight of the robot arm 10 by using the power generating device 100.

In the power generating device 100, the conductive wire bundle 25 for controlling the rotation driving of the rotor 121 is inserted through the inside of the center shaft 110. Therefore, the arrangement properties of the conductive wire bundle 25 are improved by using the power generating device 100. It is possible to prevent the conductive wire bundle 25 from being exposed to the outside. Therefore, it is possible to suppress deterioration of the conductive wire bundle 25 involved in the driving of the robot arm 10 and improve the design properties of the robot arm 10.

### B. Another Configuration Example According to the First Embodiment

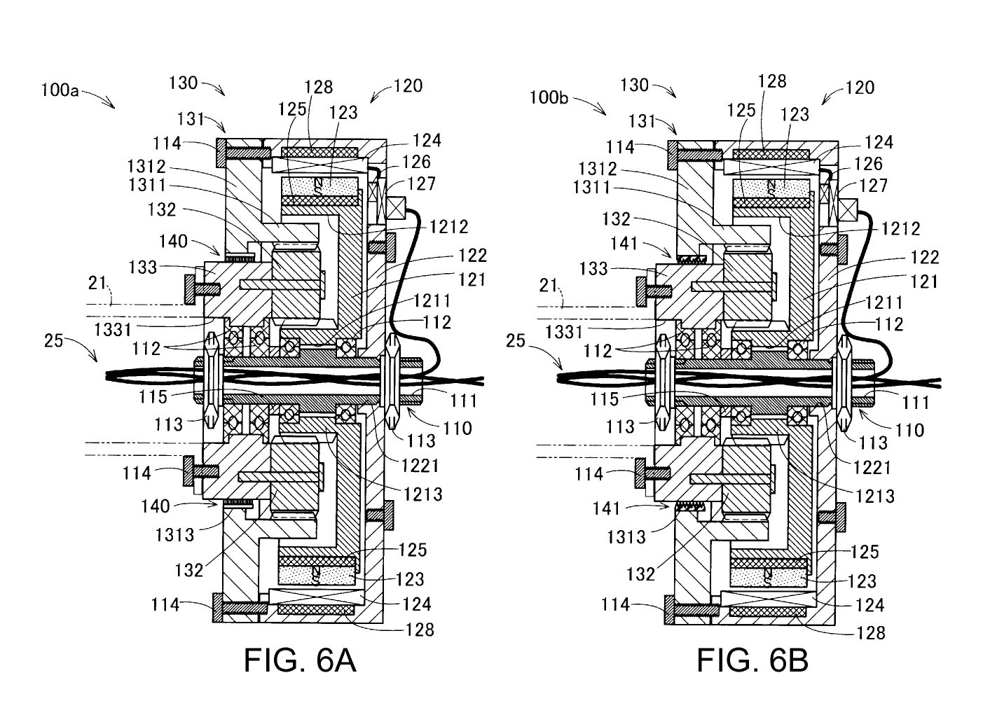

FIG. 6A is a schematic diagram showing the configuration of a power generating device 100a as another configuration example according to this embodiment. FIG. 6A is substantially the same as FIG. 3 except that a brush seal section 140 is provided. The brush seal section 140 is provided between a side surface of the load connecting section 133 and the inner circumferential surface of the opening section 1313 of the gear fixing section 131 to suppress intrusion of dust into the inside of the power generating device 100a. Consequently, deterioration of the power generating device 100a is suppressed.

FIG. 6B is a schematic diagram showing the configuration of a power generating device 100b as still another configuration example according to this embodiment. FIG. 6B is substantially the same as FIG. 6A except that a rubber seal section 141 is provided instead of the brush seal section 140. The rubber seal section 141 is provided between a side surface of the load connecting section 133 and the inner circumferential surface of the opening section 1313 of the gear fixing section 131 and hermetically seals the power generating device 100b. Consequently, it is possible to reduce a rotation loss of gears and a rotor in the power generating device 100b due to an air flow.

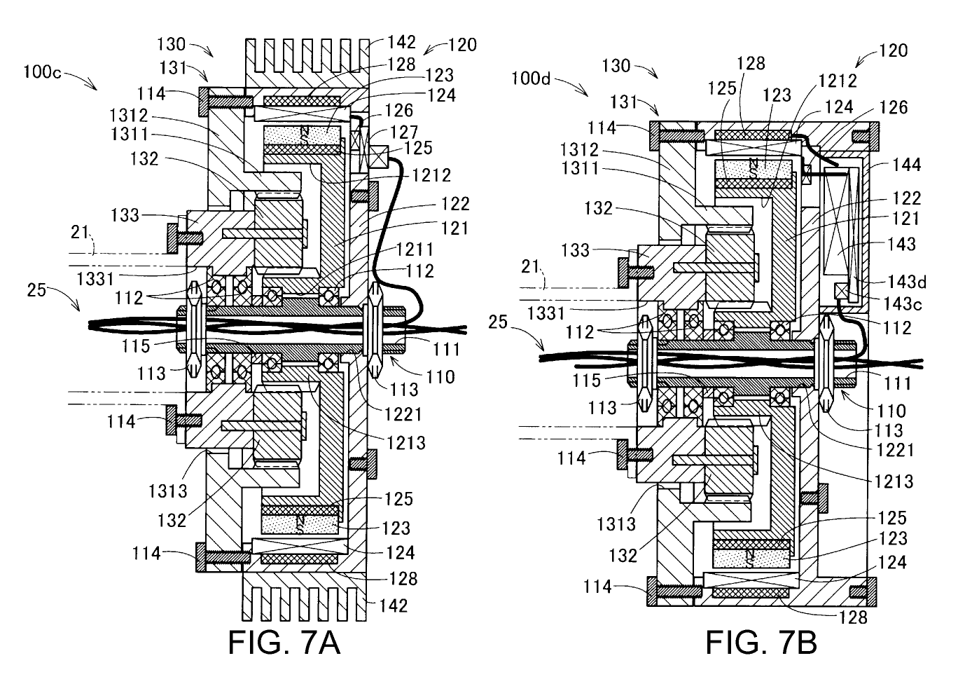

FIG. 7A is a schematic diagram showing the configuration of a power generating device 100c as still another configuration example according to this embodiment. FIG. 7A is substantially the same as FIG. 3 except that a heat exchange fin 142 is provided. The heat exchange fin 142 is provided on the outer surface of the casing 122 of the motor section 120. Consequently, it is possible to efficiently cool heat generation by a coil current in the electromagnetic coil 124 and increase output torque of the motor section 120. The heat exchange fin 142 and the coil back yoke 128 for the electromagnetic coil 124 may be arranged to be in direct contact with each other. Consequently, it is possible to improve a heat radiation effect for heat generation of the electromagnetic coil 124. A coolant jacket may be mounted on the outer circumference of the casing 122 instead of the heat exchange fin 142.

FIG. 7B is a schematic diagram showing the configuration of a power generating device 100d as still another configuration example according to this embodiment. FIG. 7B is substantially the same as FIG. 3 except that a control section 143, a communication section 143c, and a driver circuit 143d are provided on the inside of a casing 144 instead of the rotation control circuit 127. The control section 143 includes a microcomputer including a central processing unit and a main storage device and controls the communication section 143c and the driver circuit 143d. The communication section 143c executes communication of a command with the outside. The driver circuit 143d controls, according to a command of the control section 143, an electric current fed to the electromagnetic coil 124. In this configuration example, the power generating device 100d can be driven by the control section 143, the communication section 143c, and the driver circuit 143d, which are integrally provided in the power generating device 100d, according to a command transmitted from the outside.

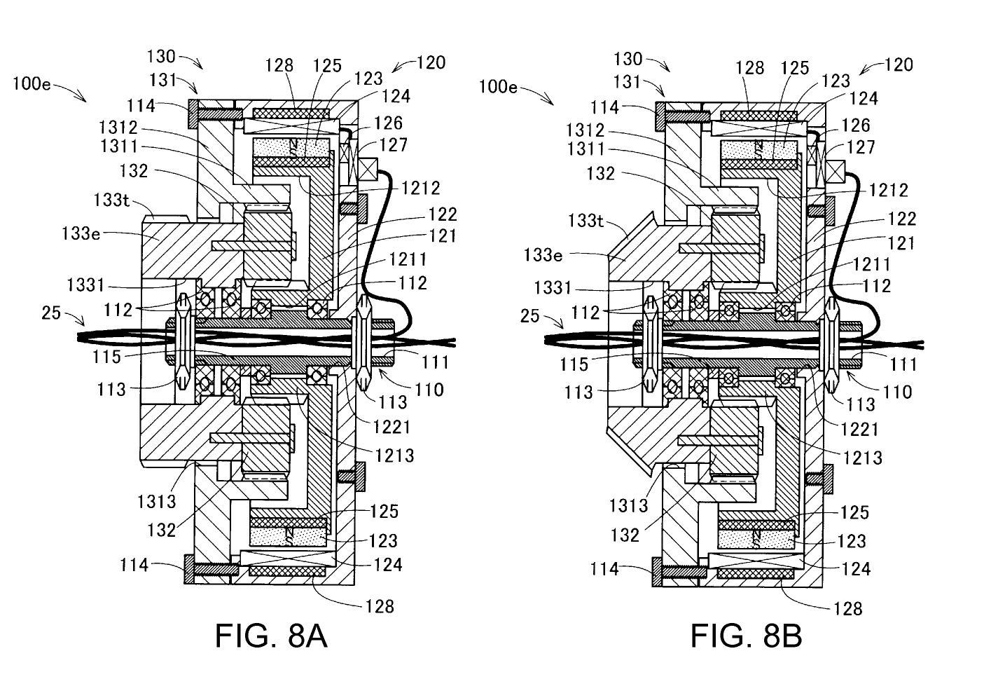

FIGS. 8A and 8B are schematic diagrams showing the configuration of a power generating device 100e as still another configuration example according to this embodiment. FIGS. 8A and 8B are substantially the same as FIG. 3 except that a load connecting section 133e is provided instead of the load connecting section 133 and the broken line indicating the rotating shaft of the first bevel gear 21 is omitted. Unlike the power generating device 100 according to the first embodiment, the power generating device 100e in the configuration example shown in FIGS. 8A and 8B is used for an actuator and a manipulator having configurations different from the robot arm 10.

In the configuration example shown in FIG. 8A, the load connecting section 133e is configured the same as the load connecting section 133 (FIG. 3) according to the first embodiment except that the load connecting section 133e is formed integrally with a spur gear, gear teeth 133t of which are provided on a sidewall surface projecting from the gear fixing section 131. In other words, in this configuration example, the load connecting section 133e functions as a planetary carrier and also functions as a gear that transmits rotation driving force to an external load.

The configuration example shown in FIG. 8B is the same as the configuration example shown in FIG. 8A except that the load connecting section 133e is formed integrally with a bevel gear. In this way, the load connecting section 133e can be formed integrally with various types of gears.

### C. Second Embodiment

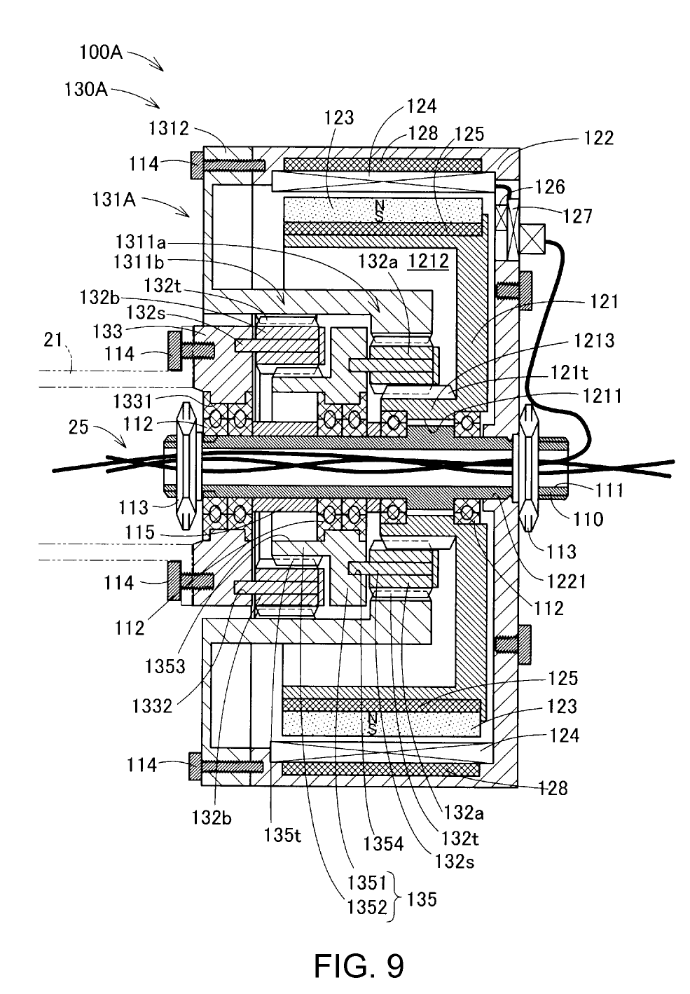

FIGS. 9 and 10 are schematic diagrams showing the configuration of a power generating device 100A according to a second embodiment of the present invention. FIG. 9 is a schematic sectional view showing an internal configuration of the power generating device 100A. FIG. 10 is a schematic disassembled sectional view showing components of the power generating device 100A in a disassembled state. The power generating device 100A has a configuration in which a reduction gear including planet gears laid in two stages and a motor are integrated. The power generating device 100A is different from the power generating device 100 (FIGS. 3 and 4) according to the first embodiment as explained below.

The power generating device 100A according to the second embodiment includes a rotating mechanism section 130A. In a gear fixing section 131A of the rotating mechanism section 130A, first and second outer gears 1311a and 1311b one of which is laid on top of the other are provided in parallel to the axis direction of the center shaft 110. When the gear fixing section 131A is fixedly attached to the casing 122, both the first and second outer gears 1311a and 1311b are housed in the recess 1212 of the rotor 121.

The first outer gear 1311a is coupled to the rotor gear 1213 via a first planetary gear 132a. In other words, the rotor gear 1213 functions as a sun gear in the planet gear in the first stage. The first planetary gear 132a is rotatably attached to a planetary carrier 135.

The planetary carrier 135 is a rotating member in which a cylindrical front stage section 1351 having a relatively large diameter and a cylindrical rear stage section 1352 having a relatively small diameter are jointly provided. The front stage section 1351 of the planetary carrier 135 is arranged between the first and second outer gears 1311a and 1311b. A shaft hole 1354 for retaining the rotating shaft 132s of the first planetary gear 132a is provided in the bottom surface of the front stage section 1351. Gear teeth 135t are formed on a sidewall surface of the rear stage section 1352. The rear stage section 1352 is arranged in an inner circumferential space of the second outer gear 1311b.

In the central part of the planetary carrier 135, a through-hole 1353 for inserting through the center shaft 110 is provided to pierce through both the front stage section 1351 and the rear stage section 1352. The bearing sections 112 for allowing the planetary carrier 135 to rotate are arranged between the through-hole 1353 and the center shaft 110. The spacer 115 is arranged between the bearing sections 112 as appropriate.

A second planetary gear 132b is arranged between the rear stage section 1352 of the planetary carrier 135 and the second outer gear 1311b. In other words, the rear stage section 1352 functions as a sun gear in the planet gear in the second stage. The second planetary gear 132b is rotatably attached to the load connecting section 133 functioning as the planetary carrier.

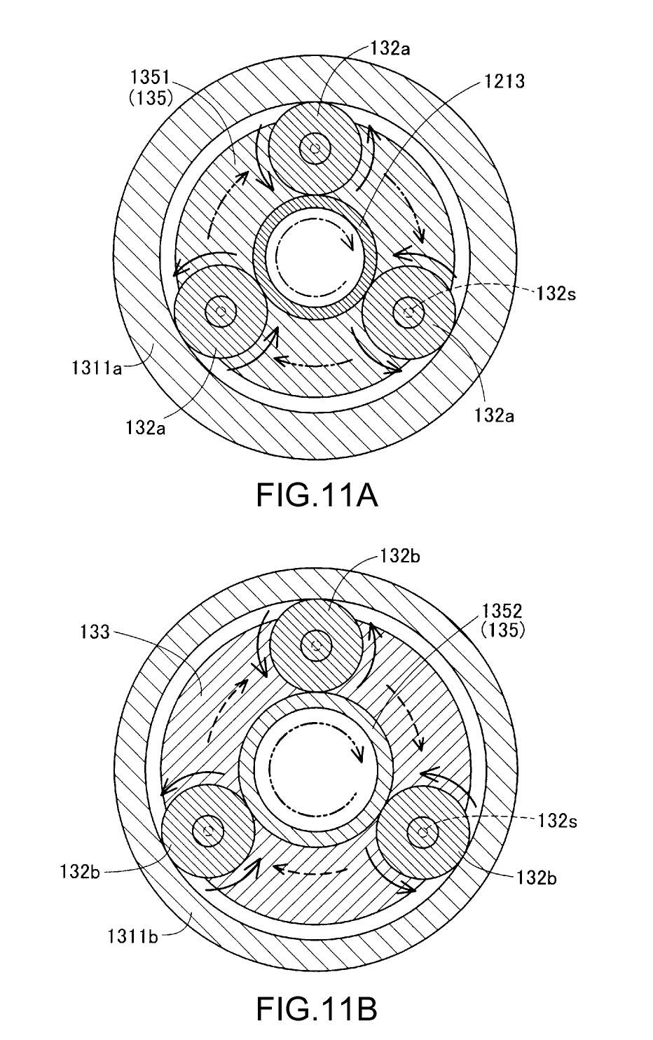

FIGS. 11A and 11B are schematic diagrams same as FIG. 5 for explaining a mechanism for transmitting rotation driving force in the two-stage planet gears of the power generating device 100A. In FIG. 11A, the planet gear in the first stage including the rotor gear 1213, the first planetary gear 132a, the first outer gear 1311a, and the front stage section 1351 of the planetary carrier 135 is shown. In the planet gear in the first stage, the first planetary gear 132a circulatingly moves on the outer circumference of the rotor gear 1213 while rotating around the rotating shaft 132s of the first planetary gear 132a according to the rotation of the rotor gear 1213. The front stage section 1351 of the planetary carrier 135 rotates according to the circulating movement of the first planetary gear 132a.

In FIG. 11A, the rotating direction of the rotor gear 1213 is indicated by an arrow of an alternate long and short dash line and the rotating direction of the first planetary gear 132a is indicated by an arrow of a solid line. The direction of the circulating movement of the first planetary gear 132a, i.e., the rotating direction of the planetary carrier 135 is indicated by an arrow of an alternate long and two short dashes line.

In FIG. 11B, the planet gear in the second stage including the rear stage section 1352 of the planetary carrier 135, the second planetary gear 132b, the second outer gear 1311b, and the load connecting section 133 is shown. In the planet gear in the second stage, the second planetary gear 132b circulatingly moves on the outer circumference of the rear stage section 1352 of the planetary carrier 135 while rotating around the rotating shaft 132s of the second planetary gear 132b according to the rotation of the rear stage section 1352 of the planetary carrier 135. The load connecting section 133 rotates according to the circulating movement of the second planetary gear 132b. Rotation driving force is transmitted to an external load connected to the load connecting section 133.

In FIG. 11B, the rotating direction of the rear stage section 1352 of the planetary carrier 135 is indicated by an arrow of an alternate long and two short dashes line. The rotating direction of the second planetary gear 132b is indicated by an arrow of a solid line. The direction of the circulating movement of the second planetary gear 132b, i.e., the rotating direction of the load connecting section 133 is indicated by an arrow of a broken line.

As explained above, in the power generating device 100A according to the second embodiment, the two-stage planet gears are housed in the recess 1212 of the rotor 121 as the reduction gear that can output rotation driving force having higher torque. The power generating device 100A is reduced in size. If the power generating device 100A is applied to the robot arm 10 (FIGS. 1A and 1B), it is possible to pivot the first to third joint sections J1 to J3 with torque higher than that in the case of the first embodiment. In the power generating device 100A, a planet gear including a larger number of stages may be configured.

### D. Third Embodiment

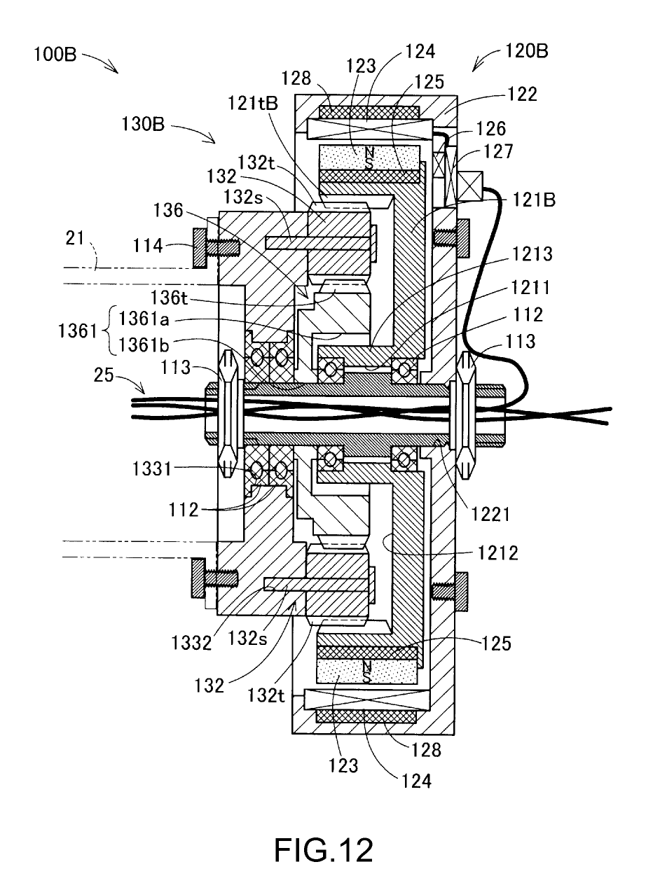

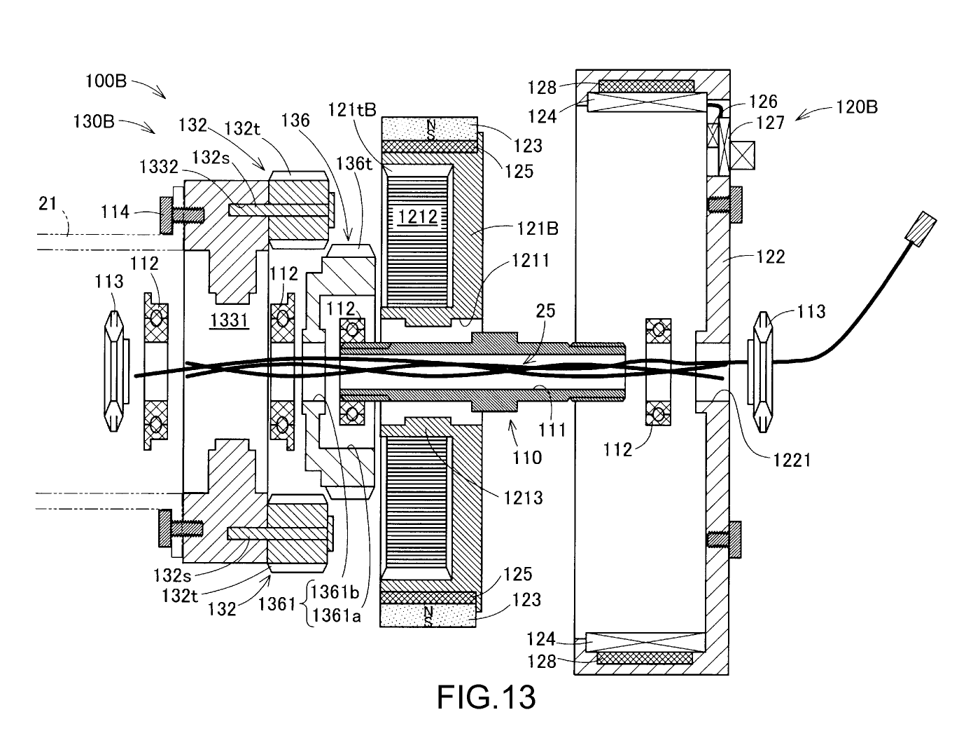

FIGS. 12 and 13 are schematic diagrams showing the configuration of a power generating device 100B according to a third embodiment of the present invention. FIG. 12 is a schematic sectional view showing an internal configuration of the power generating device 100B. FIG. 13 is a schematic disassembled sectional view showing components of the power generating device 100B in a disassembled state. The power generating device 100B has a configuration in which a planet gear functioning as a speed-increasing gear and a motor are integrated. The power generating device 100B transmits rotation driving force to the bevel gear 21. The bevel gear 21 is an external load. The power generating device 100B is different from the power generating device 100 (FIGS. 3 and 4) according to the first embodiment as explained below.

A motor section 120B in the third embodiment includes a rotor 121B. The rotor 121B has a configuration same as the configuration of the rotor 121 explained in the first embodiment except that the gear teeth 121t on the outer surface of the partition wall 1213 provided in the center are omitted and gear teeth 121tB are provided on the inner circumferential surface of a sidewall of the rotor 121B. In the power generating device 100B according to the third embodiment, the rotor 121B functions as an outer gear.

A rotating mechanism section 130B of the power generating device 100B includes a sun gear 136. The sun gear 136 is a substantially cylindrical member in which a through-hole 1361 for inserting through the center shaft 110 is provided in the center. Gear teeth 136t are formed on a sidewall surface. The through-hole 1361 includes a front stage section 1361a in which a partition wall 1213 in the center of the rotor 121B can be housed while leaving a gap and a rear stage section 1361b fixedly connected to the center shaft 110.

The planetary gear 132 is arranged in the recess 1212 of the rotor 121B and couples the sun gear 136 and the rotor 121B, which is the outer gear. The planetary gear 132 is rotatably attached to the load connecting section 133 functioning as the planetary carrier. A rotating shaft (indicated by an alternate long and two short dashes line) of the bevel gear 21 is attached to the load connecting section 133 by the fixing bolt 114.

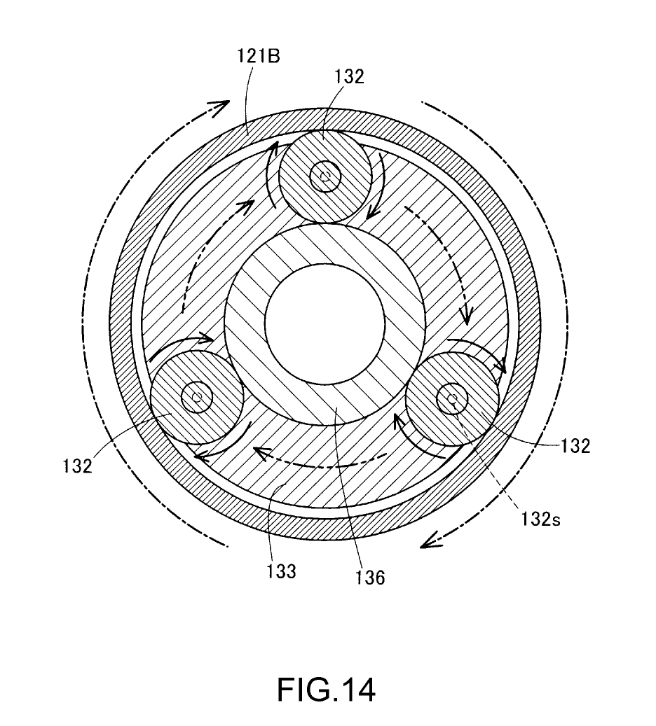

FIG. 14 is a schematic diagram same as FIGS. 11A and 11B for explaining a mechanism for transmitting rotation driving force on the inside of the power generating device 100B. The sun gear 136 is fixed to the center shaft 110. Therefore, the planetary gear 132 circulatingly moves on the outer circumference of the sun gear 136 while rotating around the rotating shaft 132s of the planetary gear 132 according to the rotation of the rotor 121B, which is the outer gear. The load connecting section 133, which is the planetary carrier, rotates according to the circulating movement of the planetary gear 132.

In FIG. 14, the rotating direction of the rotor 121B is indicated by an arrow of an alternate long and short dash line. The rotating direction of the planetary gear 132 is indicated by an arrow of a solid line. In FIG. 14, the direction of the circulating movement of the planetary gear 132, i.e., the rotating direction of the load connecting section 133 is indicated by an arrow of an alternate long and two short dashes line.

As explained above, in the power generating device 100B according to the third embodiment, the planet gear functioning as the speed-increasing gear is housed in the recess 1212 of the rotor 121B of the motor section 120. The power generating device 100B is reduced in size. Therefore, if the power generating device 100B is used, it is possible to more compactly configure an actuator and a manipulator that require high-speed rotation driving force.

In the first embodiment, the planet gear is caused to function as the reduction gear. In the third embodiment, the planet gear is caused to function as the speed-increasing gear. In the planet gear, one of the sun gear (SG), the outer gear (OG), and the planetary carrier (PC) may be set as the input section (provided integrally with or connected to the rotor 121), one of the remaining two may be set as the output section (provided integrally with or connected to the load connecting section 133), and the remaining one may be set as the fixed section (provided integrally with or connected to the stator (the casing 122)). In the planet gear, it is possible to determine whether the planet gear is used as the reduction gear or the speed-increasing gear according to which of the input section, the fixed section, and the output section is allocated to the sun gear (SG), the outer gear (OG), and the planetary carrier (PC), respectively. In other words, it is determined which of the sun gear (SG), the outer gear (0G), and the planetary carrier (PC) are set as the input section, the fixed section, and the output section according to whether the planet gear is used as the reduction gear or the speed-increasing gear. A speed reduction ratio (a speed increasing ratio) in that case can be determined according to the number of teeth of the sun gear (SG) and the outer gear (OG).

If the number of teeth of the sun gear is represented as Za and the number of teeth of the outer gear is represented as Zc, speed reduction ratios and the rotating directions of the output section with respect to the rotating directions of the input section in respective states are as described below.

| | | | Speed | Speed | |
|---|---|---|---|---|---|
| | | | reduction | increase or | Rotating |
| SG | OG | PC | ratio | decrease | direction |
| Input | Fixed | Output | Za/(Za + Zc) | Speed | Same |
| section | section | section | | reduction | direction |
| Fixed | Input | Output | Zc/(Za + Zc) | Speed | Same |
| section | section | section | | reduction | direction |
| Fixed | Output | Input | (Za + Zc)/Zc | Speed | Same |
| section | section | section | | increase | direction |
| Output | Fixed | Input | (Za + Zc)/Za | Speed | Same |
| section | section | section | | increase | direction |
| Input | Output | Fixed | −Za/Zc | Speed | Opposite |
| section | section | section | | reduction | directions |
| Output | Input | Fixed | −Zc/Za | Speed | Opposite |
| section | section | section | | increase | directions |

### E. Fourth Embodiment

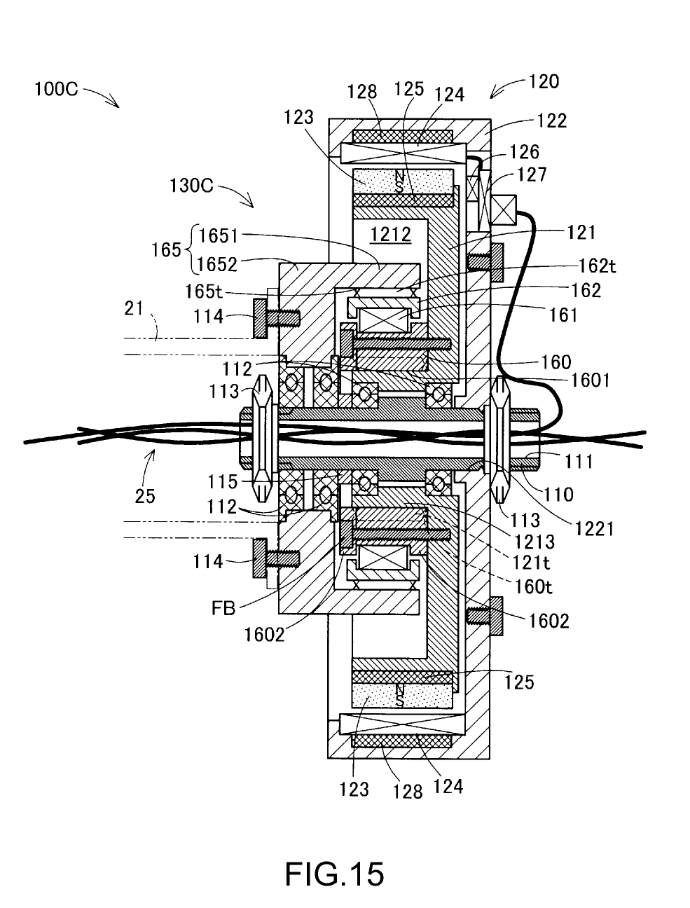

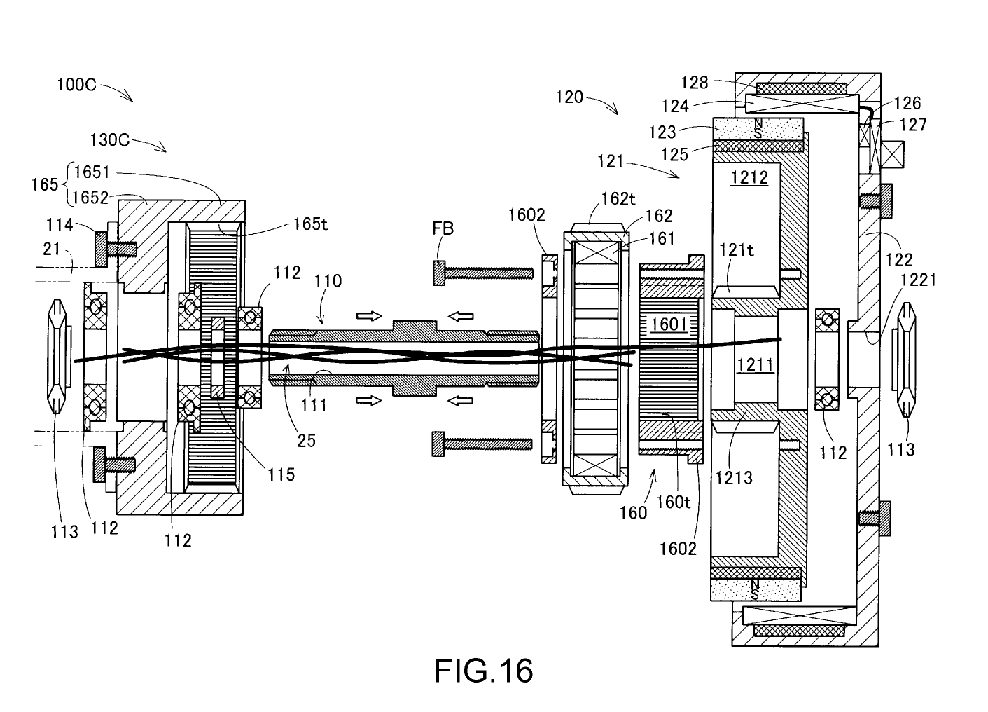

FIGS. 15 and 16 are schematic diagrams showing the configuration of a power generating device 100C according to the third embodiment of the present invention. FIG. 15 is a schematic sectional view showing an internal configuration of the power generating device 100C. FIG. 16 is a schematic disassembled sectional view showing components of the power generating device 100C in a disassembled state. The power generating device 100C has a configuration in which a harmonic drive mechanism (“harmonic drive” is a registered trademark) and a motor are integrated. The power generating device 100C transmits rotation driving force to the bevel gear 21. The power generating device 100C is different from the power generating device 100 (FIGS. 3 and 4) according to the first embodiment as explained below.

In the power generating device 100C, a wave generator 160, a flex spline 162, and a circular spline 165 included in the harmonic drive mechanism are housed in the recess 1212 of the rotor 121 as a rotating mechanism section 130C. The wave generator 160 is a substantially elliptically cylindrical member, the bottom surface of which has a substantially elliptical shape.

In the wave generator 160, a through-hole 1601 piercing through the wave generator 160 in a center axis direction thereof (the left right direction on the paper surface) is provided. Gear teeth 160t are formed on the inner wall surface of the through-hole 1601. The wave generator 160 is fastened to the rotor 121 by a fastening bolt FB in a state in which the rotor gear 1213 is housed in a fitting manner in the through-hole 1601. Consequently, the wave generator 160 rotates according to the rotation of the rotor 121.

Brim sections 1602 projecting in the outer circumferential direction are provided at both ends of the wave generator 160. The brim sections 1602 prevent the flex spline 162 arranged on the outer circumference of the wave generator 160 from dropping. In FIG. 16, a state in which one brim section 1602 is separated in order to attach the flex spline 162 is shown. The separated brim section 1602 is fixed by the fastening bolt FB after the flex spline 162 is arranged.

The flex spline 162 is an annular member having a bend deformable according to the rotation of the wave generator 160. Gear teeth 162t are formed on the outer circumferential surface of the flex spline 162. A bearing 161 for smoothing the rotation of the wave generator 160 is arranged on the inner circumferential surface of the flex spline 162.

The circular spline 165 includes a front stage section 1651 that is housed in the recess 1212 of the rotor 121 and houses the flex spline 162 on the inner side and a rear stage section 1652 through which the center shaft 110 is inserted and to which the rotating shaft of the bevel gear 21 is connected. Gear teeth 165t that mesh with the gear teeth 162t of the flex spline 162 are formed on the inner circumferential surface of the front stage section 1651. The bearing sections 112 for allowing the circular spline 165 to pivot are arranged between the rear stage section 1652 and the center shaft 110.

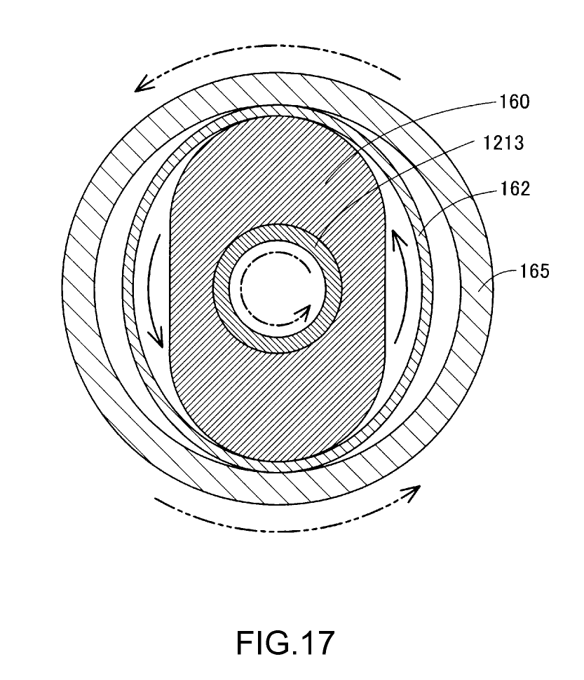

FIG. 17 is a schematic diagram same as FIG. 14 for explaining a mechanism for transmitting rotation driving force on the inside of the power generating device 100C. In FIG. 17, the bearing 161 provided on the inner side of the flex spline 162 is not shown. In the power generating device 100C, the wave generator 160 rotates (indicated by an arrow of a solid line) according to the rotation of the rotor gear 1213 (indicated by an arrow of an alternate long and short dash line).

The wave generator 160 presses, in a long circle direction thereof, the flex spline 162 to the circular spline 165 side and brings the flex spline 162 and the circular spline 165 into contact with each other. Consequently, in the long circle direction of the wave generator 160, the gear teeth 162t (not shown) of the flex spline 162 and the gear teeth 165t (not shown) of the circular spline 165 mesh with each other. In a short circle direction of the wave generator 160, the flex spline 162 and the circular spline 165 are in a noncontact state.

According to the coupling of the flex spline 162 and the circular spline 165 in the long circle direction of the wave generator 160, the rotation of the wave generator 160 is transmitted to the circular spline 165. In FIG. 17, the rotating direction of the circular spline 165 is indicated by an arrow of an alternate long and two short dashes line.

In the harmonic drive mechanism, in general, a backlash can be omitted. Therefore, highly accurate transmission of rotation is possible. In the power generating device 100C according to the third embodiment, the rotating mechanism section 130C included in the harmonic drive mechanism is integrally housed in the recess 1212 of the rotor 121. Therefore, with the power generating device 100C, it is possible to configure an actuator and a manipulator that are compact and have high operation accuracy.

In the harmonic drive mechanism, as in the planet gear, one of the wave generator 160, the flex spline 162, and the circular spline 165 may be set as the input section, one of the remaining two may be set as the fixed section, and the remaining one may be set as the output section. Consequently, it is possible to use the harmonic drive mechanism as a reduction gear or a speed-increasing gear. A diaphragm may be connected to the flex spline 162 and may be set as the input section, the fixed section, or the output section instead of the flex spline 162.

### F. Fifth Embodiment

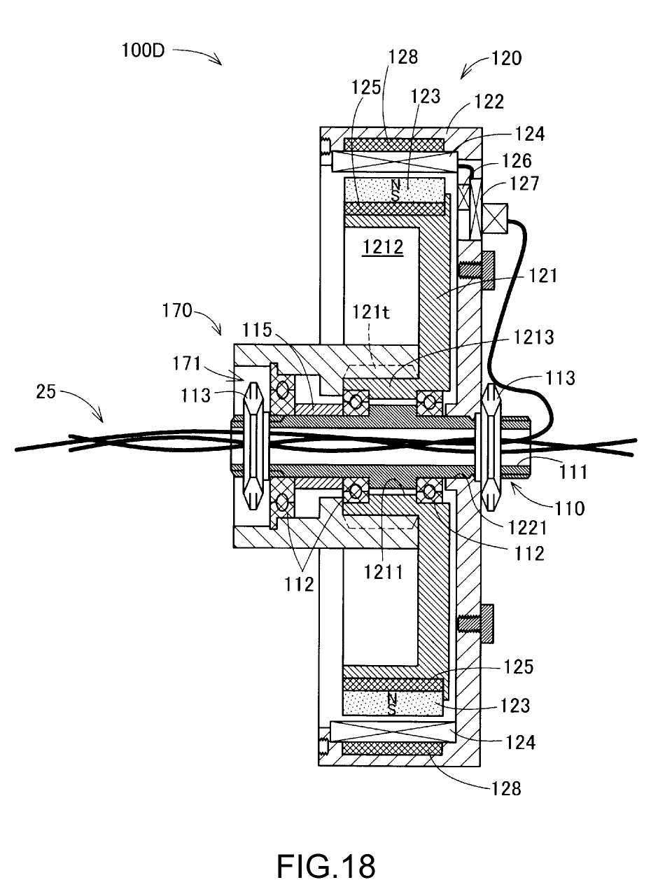

FIG. 18 is a schematic sectional view showing the configuration of a power generating device 100D according to a fifth embodiment of the present invention. FIG. 18 is substantially the same as FIG. 3 except that a rotating shaft 170 is provided instead of the rotating mechanism section 130. In the power generating device 100D, the rotating shaft 170 is replaceably attached to the rotor gear 1213 of the rotor 121.

The rotating shaft 170 includes a through-hole 171 through which the center shaft 110 is inserted in the axis direction. Gear teeth are provided on the inner wall surface on the rotor 121 side of the through-hole 171 such that the rotor gear 1213 is housed in a fitting manner. The bearing sections 112, the bearing ring 113, and the spacer 115 are arranged on a side of the through-hole 171 opposite to the rotor 121. With this configuration, the rotating shaft 170 rotates together with the rotor 121.

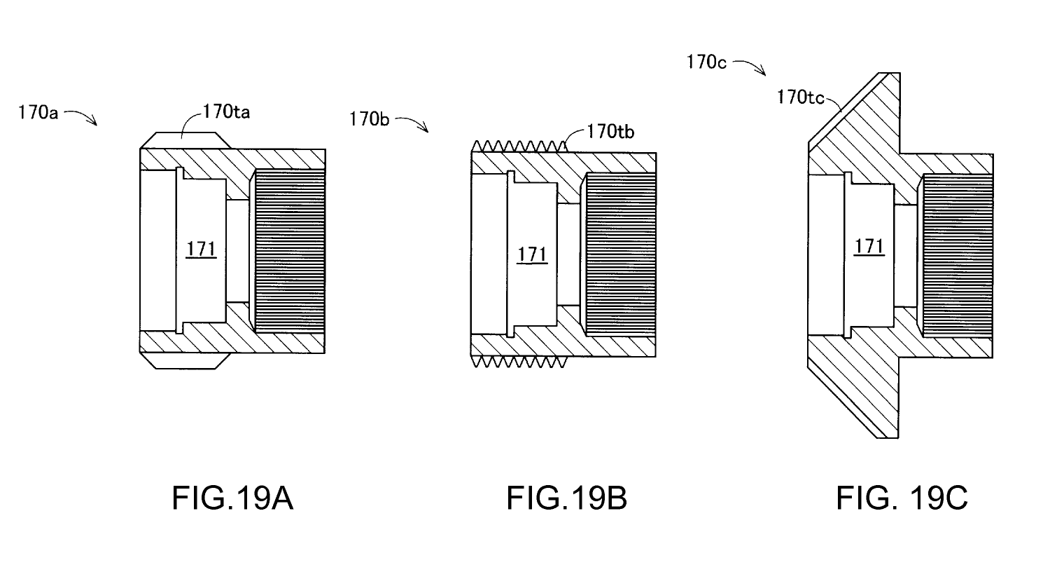

FIGS. 19A to 19C are schematic diagrams showing types of rotating shafts attached to the rotor 121 instead of the rotating shaft 170 in the power generating device 100D. In a rotating shaft 170a shown in FIG. 19A, linear gear teeth 170ta are provided on the outer surface on the distal end side (the left side on the paper surface). The rotating shaft 170a functions as a spur gear. In a rotating shaft 170b shown in FIG. 19B, gear teeth 170tb extending in a spiral shape are provided on the distal end side. The rotating shaft 170b functions as a screw gear. In a rotating shaft 170c shown in FIG. 19C, taper-like gear teeth 170tc are provided on the distal end side. The rotating shaft 170c functions as a bevel gear.

As explained above, in the power generating device 100D according to the fifth embodiment, the various rotating shafts 170 and 170a to 170c are replaceably attached to the rotor 121 of the motor section 120. Therefore, the universality of the power generating device 100D is improved. A part of the rotating shafts 170 and 170a to 170c used for the power generating device 100D is housed in the recess 1212 of the rotor 121. Therefore, the power generating device 100D is reduced in size.

### G. Sixth Embodiment

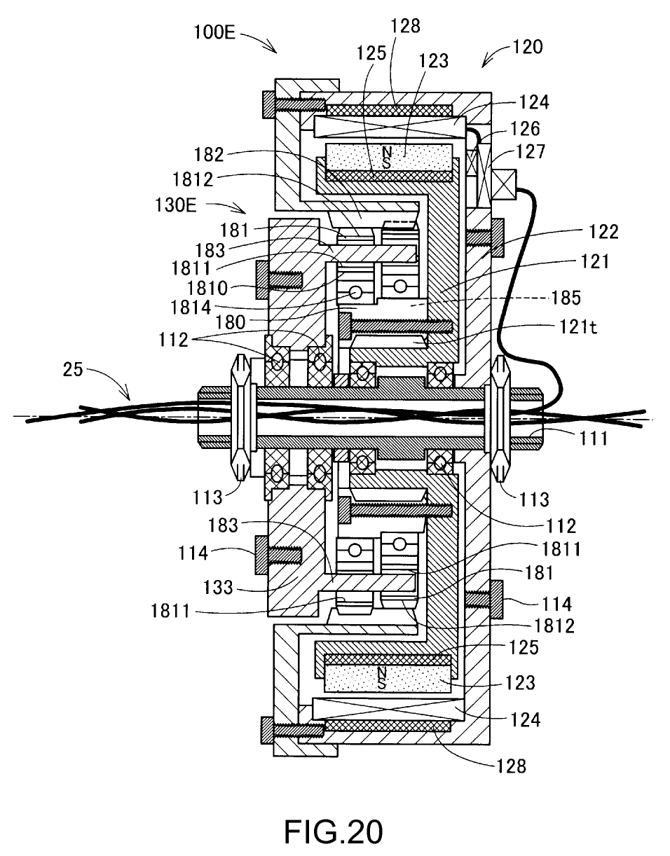

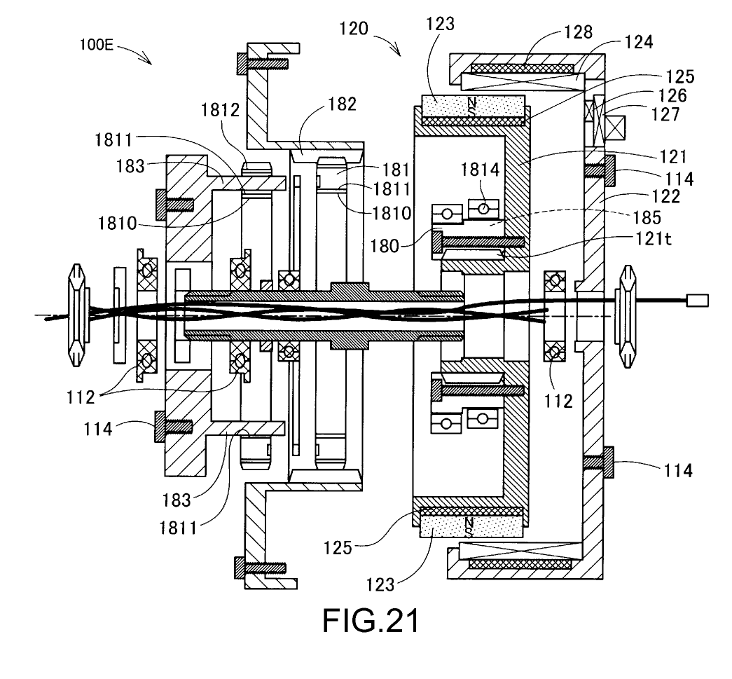

FIGS. 20 and 21 are schematic diagrams showing the configuration of a power generating device 100E according to a sixth embodiment of the present invention. FIG. 20 is a schematic sectional view showing an internal configuration of the power generating device 100E. FIG. 21 is a schematic disassembled sectional view showing components of the power generating device 100E in a disassembled state. The power generating device 100E has a configuration in which a cycloidal mechanism and a motor are integrated. The power generating device 100E transmits rotation driving force to the load connecting section 133. The power generating device 100E is different from the power generating device 100 according to the first embodiment (FIGS. 3 and 4) as explained below. The power generating device 100E includes a cycloidal mechanism in the recess 1212 of the rotor 121 as a rotating mechanism section 130E.

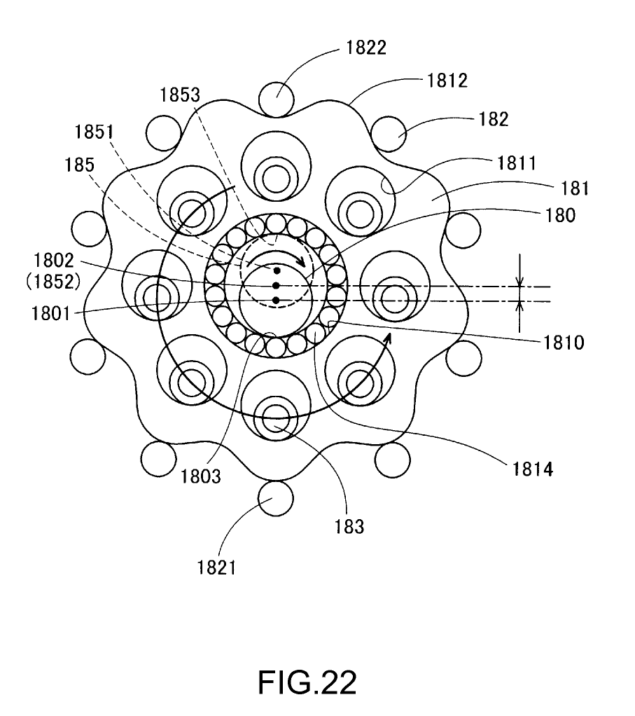

FIG. 22 is an explanatory diagram schematically showing the cycloidal mechanism. The cycloidal mechanism includes eccentric bodies 180 and 185, a curved plate 181, outer pins 182, inner pins 183, and a bearing 1814. The curved plate 181 has a substantially disc shape. The curved plate 181 includes a center hole 1810 in the central part and includes eight inner pin holes 1811 around the center hole 1810. The inner pin holes 1811 are arranged on the circumference at an interval of 45 degrees. The outer circumference of the curved plate 181 has an epitrochoid parallel line shape. In this embodiment, the number of peaks of the epitrochoid parallel shape is nine. When the curved plate 181 is rotated 40 degrees, the epitrochoid parallel shapes overlap. In this embodiment, as shown in FIG. 20, the cycloidal mechanism includes two curved plates 181. The two curved plates 181 are shifted 180 degrees from each other. As a result, convex portions of the epitrochoid parallel line shape of one curved plate 181 are located in concave portions of the epitrochoid parallel line shape of the other curved plate 181. In FIG. 22, only one curve plate 181 is shown to prevent the figure from becoming hard to see.

The outer pins 182 are members, the curved plate 181 side of which is formed in a substantially circular shape. The outer pins 182 may be columnar bars. In this embodiment, there are ten outer pins 182. The outer pins 182 are arranged on the circumference at an interval of 36 degrees. The outer pins 182 are arranged in contact with the outer circumference of the curved plate 181. When an outer pin 1821 among the outer pins 182 is in contact with the top of the convex portion of the epitrochoid parallel line shape, an outer pin 1822 in a symmetrical position of the outer pin 1821 is in contact with the bottom of the concave portion of the epitrochoid parallel line shape of the curved plate 181. In FIGS. 20 and 21, the outer pin 1822 and the curved plate 181 are shown as being in contact with each other as a concavity and a convexity of gear teeth.

The inner pins 183 are columnar bars. The number of the inner pins 183 is a number same as the number of inner pin holes 1811 (eight). The inner pins 183 are arranged on the circumference at an interval of 45 degrees. The diameter of the inner pins 183 is formed smaller than the size of the inner pin holes 1811. The inner pins 183 are inserted into the inner pin holes 1811. The circumference on which the inner pins 183 are arranged and the circumference on which the inner pin holes 1811 are arranged have the same size.

The eccentric bodies 180 and 185 have a columnar shape. A center 1801 of the eccentric body 180 is shifted from a rotation center 1802 of the eccentric body 180. A center 1851 of the eccentric body 185 is shifted from a rotation center 1852 of the eccentric body 185. The rotation center 1802 of the eccentric body 180 and the rotation center 1852 of the eccentric body 185 are the same point (axis). The rotation center 1802 of the eccentric body 180 (the rotation center 1852 of the eccentric body 185) is located in the position of the center of gravity of the center 1801 of the eccentric body 180 and the center 1851 of the eccentric body 185. The diameter of the eccentric bodies 180 and 185 are formed smaller than the size of the center hole 1810. The eccentric bodies 180 and 185 are inserted into the center hole 1810. The bearing 1814 for smoothing contact of the center hole 1810 and the eccentric bodies 180 and 185 is arranged between the center hole 1810 and the eccentric bodies 180 and 185. On the opposite side of the rotation centers 1802 and 1852 viewed from the center 1801, the eccentric bodies 180 and 185 are in contact with the bearing 1814 arranged in the center hole 1810. Points of the contact are referred to as contact points 1803 and 1853.

Referring back to FIG. 20, a connection relation of the cycloidal mechanism in the sixth embodiment is explained. In the sixth embodiment, the eccentric bodies 180 and 185 are formed integrally with the rotor 121. The outer pins 182 are formed integrally with the stator (the casing 122). The inner pins 183 are formed integrally with the load connecting section 133. In other words, the eccentric body 180 is the input section, the outer pins 182 are the fixed section, and the inner pins 183 are the output section.

An operation performed when the cycloidal mechanism is connected as shown in FIG. 20 is explained with reference to FIG. 22. When the rotor 121 (FIG. 20) rotates, the eccentric body 180 also rotates. At this point, the eccentric body 180 rotates around the rotation center 1802. For example, as shown in FIG. 22, it is assumed that the eccentric body 180 rotates clockwise. At this point, the position of the contact point 1803 also rotates clockwise. Then, the curved plate 181 receives force from the eccentric body 180 via the bearing 1814, revolves counterclockwise along the circumference on which the outer pins 182 are arranged, and auto-rotates. When the curved plate 181 auto-rotates, the positions of the inner pin holes 1811 revolve. When the inner pin holes 1811 revolve, since the inner pin holes 1811 push the inner pins 183, the inner pins 183 revolve along the circumference on which the inner pins 183 are arranged. In this embodiment, when the eccentric body 180 rotates once, the curved plate 181 rotates 1/9 of a full turn. For example, the number of the convex portions of the epitrochoid parallel line shape of the curved plate 181 is set to n and the number of the outer pins is set to (n+1). When the eccentric body 180 rotates once, the curved plate 181 rotates 1/n of a full turn. Therefore, it is possible to obtain an extremely large speed reduction ratio. Since sliding contact is converted into rolling contact by the outer pins 182, a mechanical loss is extremely small and extremely high gear efficiency can be obtained.

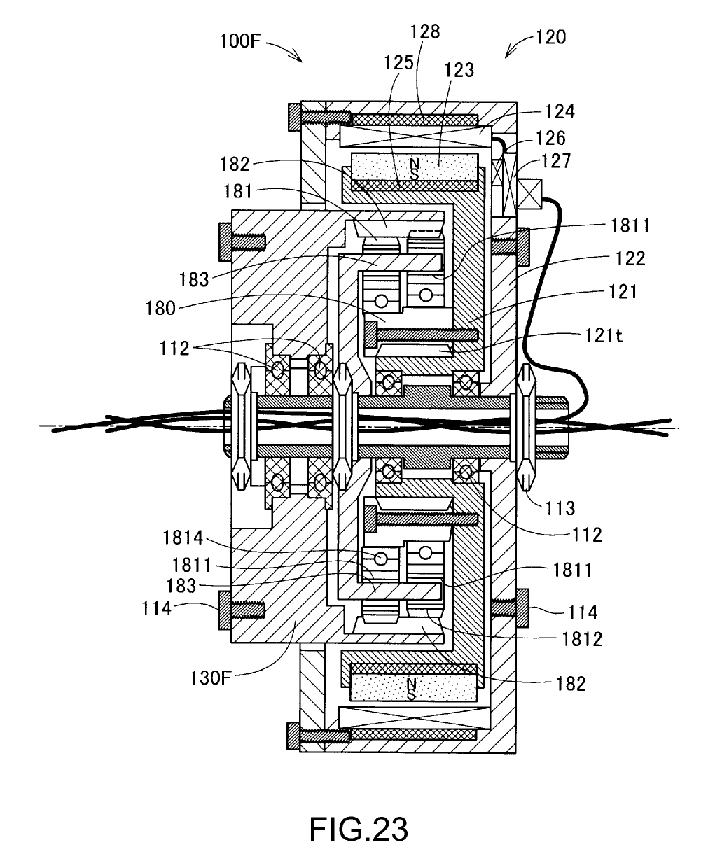

FIG. 23 is a schematic diagram showing the configuration of a power generating device 100F according to a modification of the sixth embodiment. In the power generating device 100E shown in FIG. 20, the eccentric body 180 is provided integrally with the rotor 121 to be set as the input section, the outer pins 182 are provided integrally with the stator (the casing 122) to be set as the fixed section, and the inner pins 183 are provided integrally with the load connecting section 133 to be set as the output section. In the power generating device 100F, the inner pins 183 are provided integrally with the stator (the casing 122) to be changed to the fixed section and the outer pins 182 are provided integrally with the load connecting section 133 to be changed to the output section. Even if the power generating device 100F is configured in this way, the power generating device 100F can configure a reduction gear.

In the cycloidal mechanism, one of the outer pins 182 and the inner pins 183 are set as the input section, the other are set as the fixed section, and the eccentric body 180 is set as the output section. This makes it possible to cause the cycloidal mechanism to function as a speed-increasing gear as well. In this way, in the cycloidal mechanism, one of the eccentric body 180, the outer pins 182, and the inner pins 183 is set as the input section, one of the remaining two is set as the fixed section, and the remaining one is set as the output section. This makes it possible to cause the cycloidal mechanism to function as a reduction gear or a speed-increasing gear.

In this embodiment, the cycloidal mechanism includes the two curved plates 181. However, the number of the curved plates 181 may be one or may be three or more. For example, when the number of the curved plates 181 is m, the curved plates 181 are arranged to be shifted 360/m degrees from one another. In this case, the number of the eccentric bodies 180 is m same as the number of the curved plates 181. The eccentric bodies 180 have a shape in which m columns are connected. Segments that connect centers 1801 of the columns and the rotation center 1802 are shifted 360/m degrees from one another. The rotation center 1802 is located in the center of gravity of the centers 1801 of the columns.

### H. Seventh Embodiment

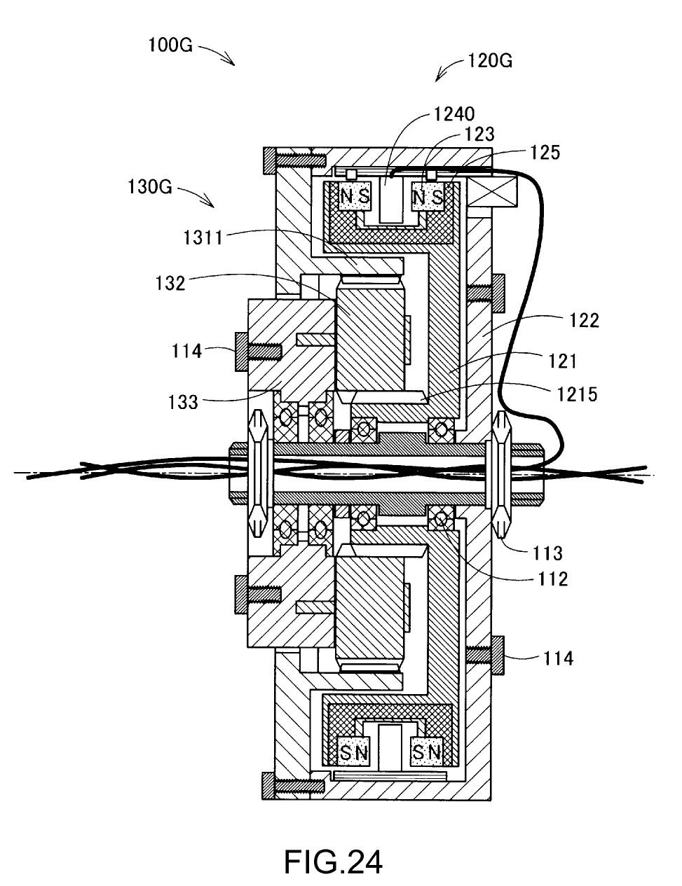

FIG. 24 is a schematic diagram showing the configuration of a power generating device 100G according to a seventh embodiment. In the power generating device 100 explained in the first embodiment, the motor section 120 includes the radial gap type motor. However, the power generating device 100G according to the seventh embodiment is different in that a motor section 120G includes an axial gap type motor. The motor section 120G includes the permanent magnet 123 and an electromagnetic coil group 1240.

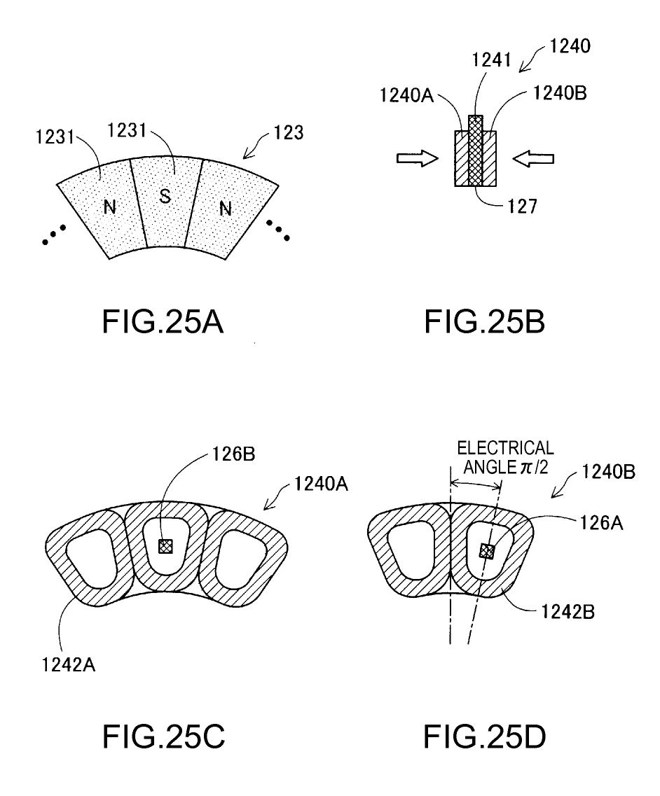

FIGS. 25A and 25B are explanatory diagrams showing the configuration of a permanent magnet and an electromagnetic coil group. FIG. 25A is an explanatory diagram showing the configuration of the permanent magnet. In the permanent magnet 123, fan-shaped plural permanent magnets 1231 are arranged in a disc shape. The direction of magnetic fluxes of the permanent magnet 1231 is a normal direction of the disc shape. Two permanent magnets 123 are provided across the electromagnetic coil group 1240.

FIG. 25B is an explanatory diagram showing a part of a sectional view of the electromagnetic coil group. The electromagnetic coil group 1240 includes an A-phase electromagnetic coil 1240A, a B-phase electromagnetic coil 1240B, and a circuit board 1241. The circuit board 1241 is arranged to be held between the A-phase electromagnetic coil 1240A and the B-phase electromagnetic coil 1240B. The A-phase electromagnetic coil 1240A and the B-phase electromagnetic coil 1240B are respectively arranged to be opposed to the permanent magnets 123.

FIG. 25C is an explanatory diagram showing a part of a plan view of the A-phase electromagnetic coil. FIG. 25D is an explanatory diagram showing a part of a plan view of the B-phase electromagnetic coil. The A-phase electromagnetic coil 1240A and the B-phase electromagnetic coil 1240B have the same structure. Therefore, the A-phase electromagnetic coil 1240A is explained as an example. The A-phase electromagnetic coil 1240A includes plural electromagnetic coils 1242A. The electromagnetic coils 1242A are wound in a fan shape and arranged in a disc shape. The electromagnetic coils 1242A and B-phase electromagnetic coils 1242B are arranged to be shifted from each other by π/2 in an electrical angle. In one electromagnetic coil among the electromagnetic coils 1242A, a magnetic sensor 126B for detecting a magnetic flux of the permanent magnet 123 is arranged. An output of the magnetic sensor 126B is used to control and drive the electromagnetic coils 1242A. Similarly, in one electromagnetic coil among the electromagnetic coils 1242B, a magnetic sensor 126A for detecting a magnetic flux of the permanent magnet 123 is arranged. An output of the magnetic sensor 126A is used to control and drive the electromagnetic coils 1242B.

As explained above, in the power generating device, besides the radial gap type motor, the axial gap type motor can be used as the motor section. In the power generating device 100G according to the seventh embodiment, the planet gear is used as the rotating mechanism section 130G. However, a harmonic drive mechanism and a cycloidal mechanism may be used instead of the planet gear.

### I. Eighth Embodiment

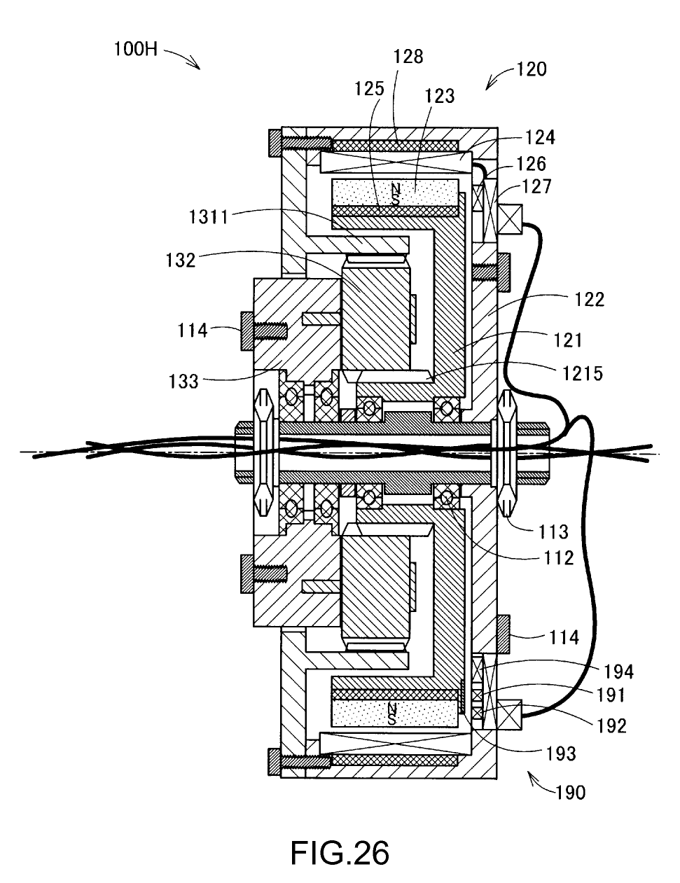

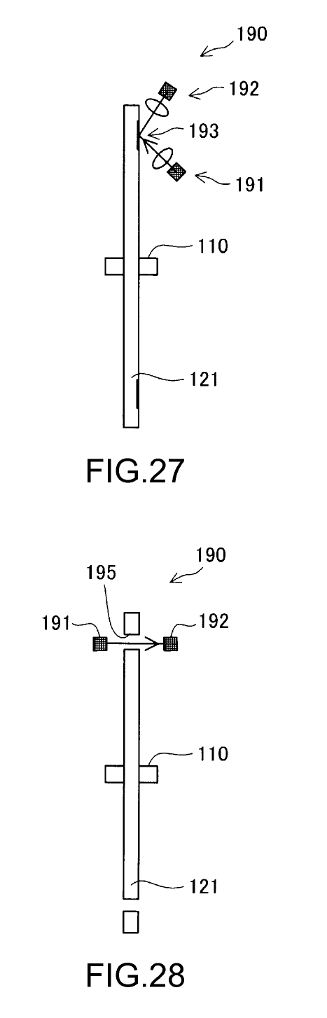

FIG. 26 is a schematic diagram showing the configuration of a power generating device 100H according to an eighth embodiment. FIG. 27 is an explanatory diagram showing an example of the configuration of an encoder. The power generating device 100H according to the eighth embodiment includes an encoder 190 in addition to the components of the power generating device 100 according to the first embodiment. The encoder 190 includes a light emitting section 191, a light receiving section 192, a reflection plate 193, and an encoder circuit 194. The light emitting section 191, the light receiving section 192, and the encoder circuit 194 are arranged on the stator (the casing 122). The reflection plate 193 is arranged on the rotor 121. Light irradiated from the light emitting section 191 is reflected on the reflection plate 193 and detected by the light receiving section 192. The encoder 190 includes reflection plates 193 in plural rows along the circumference in the rotating direction of the rotor 121. Reflected light from the reflection plate 193 in each of the rows indicates a binary number. The binary number increases or decreases by one as the rotor 121 rotates once. Since the reflection plate 193 is configured in this way, the encoder circuit 194 can accurately determine the rotating position of the rotor 121.

FIG. 28 is an explanatory diagram showing a modification of the configuration of the encoder. In this modification, the encoder 190 includes the light emitting section 191, the light receiving section 192, and a hole 195. The light emitting section 191 and the light receiving section 192 are arranged on the stator (the casing 122). The light emitting section 191 and the light receiving section 192 are provided across the rotor 121. The hole 195 is formed between the light emitting section 191 and the light receiving section 192 of the rotor 121. Like the reflection plates 193, holes 195 are provided in plural rows along the circumference of the rotating direction of the rotor 121. Light transmitted through the hole 195 in each of the rows indicates a binary number. The binary number increases or decreases by one as the rotor 121 rotates once. In this way, a transmissive encoder may be used rather than a reflective encoder. In the case of the transmissive encoder, in order to maintain the strength of the rotor 121, the hole 195 may be filled using a light transmissible material instead of providing the hole 195. In the eighth embodiment shown in FIG. 27 or the modification of the eighth embodiment shown in FIG. 28, two sets of the light emitting section 191 and the light receiving section 192 may be provided to realize two-phase encoders. When the two-phase encoders are realized, outputs of the encoders desirably have a phase difference different from an integral multiple of π in an electrical angle. This is because, if the outputs of the encoders are integral multiples of π in an electrical angle, it is difficult to detect a rotating direction from the outputs of the encoders. In the eighth embodiment shown in FIG. 27, the reflection plate 193 is used. However, a refractive material that refracts light may be used instead of the reflection plate 193.

### J. Modifications

The invention is not limited to the embodiments explained above and can be carried out various forms without departing from the spirit of the invention. For example, modifications explained below are possible.

### J1. Modification 1

In the first embodiment, the power generating device 100 is used as the power source for the joint sections J1 to J3 of the robot arm 10. However, the power generating device 100 according to the first embodiment and the power generating devices 100A to 100H according to the other embodiments may be used as power sources for other actuators and manipulators, a power source for a moving body, or the like.

### J2. Modification 2

In the embodiments, the power generating devices 100 and 100A to 100H transmit rotation driving force generated by the motor section 120 to the external load. However, the power generating devices 100 and 100A to 100H may function as a power generating device that causes the motor section 120 to generate electric power using rotation driving force transmitted from the external load. In this way, the invention can be applied not only to the power generating device that generates motive power using electromagnetic force but also to an electric machine device that converts motive power and electric power using the rotor, the stator, and the rotating mechanism.

### J3. Modification 3

In the embodiments, all or a part of the rotating mechanism such as the planet gear, the harmonic drive mechanism, the cycloidal mechanism, or the like is housed in the recess 1212 of the rotor 121. In other words, when viewed in a direction perpendicular to the center shaft 110, the rotor 121 and all or a part of the rotating mechanism are configured to overlap. However, all or apart of another rotating mechanism may be housed in the recess 1212 of the rotor 121. For example, a rotating mechanism that transmits the rotation of the rotor 121 using the rotation of a chain or a belt may be housed in the recess 1212 of the rotor 121.

### J4. Modification 4

In the embodiments, the conductive wire bundle 25 is inserted through the through-hole 111 of the center shaft 110. However, the through-hole 111 of the center shaft 110 may be omitted. The conductive wire bundle 25 may be disposed on the outside of the power generating devices 100 and 100A to 100H.

### J5. Modification 5

In the embodiments, the rotor 121 includes, as the housing space for housing the rotating mechanism, the recess 1212 formed as the substantially annular groove. However, the rotor 121 may include a space of another configuration as the housing space for housing the rotating mechanism. For example, the rotor 121 may be configured to include a framework of a basket type having a cylindrical shape and a space surrounded by the framework may be used as the housing space for the rotating mechanism.

### J6. Modification 6

In the first embodiment, the fourth base section 14 pivots relatively to the third base section 13 around the joint section J3. However, a fifth base section that does not move relatively to the third base section 13 may be included in the third base section 13. The fourth base section 14 and the fifth base section may form a gripping section that grips an object. Specifically, a gripping section for gripping an object may be provided at the distal end of a robot arm. The power generating device 100 according to the first embodiment and the power generating devices 100A to 110H according to the other embodiments may be used for driving of the gripping section. The power generating device 100 according to the first embodiment and the power generating devices 100A to 110H according to the other embodiments may be used a motor or a driving section that moves the entire robot arm 10.

In the explanation of the embodiments, the bevel gear 21 is connected to the load connecting section 133. However, an external load only has to be connected to the load connecting section 133. The shape of the external load is not limited to the bevel gear 21.

The present application claims the priority based on Japanese Patent Applications No. 2011-002759 filed on Jan. 11, 2011, the disclosures of which are hereby incorporated by reference in their entireties.

What is claimed is:

1. An electric machine device comprising:
a rotor including a rotor magnet arranged along an outer circumference of a center shaft;
a stator arranged on an outer circumference of the rotor;
a rotating mechanism coupled to the rotor and used for transmission of rotation driving force; and
a load connecting section that connects the rotating mechanism and a load, wherein
in the rotor, a housing space that is opened on one side in an axis direction of the center shaft and houses at least a part of the rotating mechanism is formed between the center shaft and the rotor magnet,
the rotating mechanism includes:
an input section connected to or formed integrally with the rotor;
a fixed section connected to or formed integrally with the stator, and
an output section connected to or formed integrally with the load connecting section, and
the rotating mechanism functions as a speed-increasing gear or a reduction gear.

2. The electric machine device according to claim 1, wherein
the center shaft includes a through-hole extending in the axis direction of the center shaft, and
a conductive wire that transmits electricity for controlling rotation of the rotor is inserted through the through-hole.

3. The electric machine device according to claim 1, wherein
the rotating mechanism includes a planet gear including:
a sun gear arranged in a central part of the rotating mechanism;
an outer gear arranged in an outer circumferential part of the rotating mechanism;
a planetary gear arranged between the sun gear and the outer gear; and
a planetary carrier to which the planetary gear is connected, and
in the rotating mechanism, one of the sun gear, the outer gear, and the planetary carrier is the input section, one of the remaining two is the fixed section, and the remaining one is the output section.

4. The electric machine device according to claim 1, wherein
the rotating mechanism includes a harmonic drive mechanism (“harmonic drive” is a registered trademark) including:
a wave generator arranged in a central part of the rotating mechanism;
a circular spline arranged in an outer peripheral part of the rotating mechanism; and
a flex spline arranged between the wave generator and the circular spline, and
in the rotating mechanism, one of the wave generator, the circular spline, and the flex spline is the input section, one of the remaining two is the fixed section, and the remaining one is the output section.

5. The electric machine device according to claim 1, wherein
the rotating mechanism includes a cycloidal mechanism including:
a curved plate having an epitrochoid parallel curve shape at an outer edge and having a first hole formed in a center and plural second holes formed around the first hole;
outer pins arranged in contact with the epitrochoid parallel curve of the curved plate;
inner pins arranged in the second holes; and
an eccentric body arranged in the first hole, and
one of the eccentric body, the outer pins, and the inner pins is the input section, one of the remaining two is the fixed section, and the remaining one is the output section.

6. The electric machine device according to claim 1, further comprising an encoder formed integrally with the rotor.

7. An actuator comprising the electric machine device according to claim 1.

8. An actuator comprising the electric machine device according to claim 2.

9. An actuator comprising the electric machine device according to claim 3.

10. A motor comprising:
a center shaft;
a rotor including a rotor magnet arranged along an outer circumference of the center shaft;
a stator arranged on an outer circumference of the rotor;
a rotating mechanism coupled to the rotor and used for transmission of rotation driving force; and
a load connecting section that connects the rotating mechanism and a load, wherein
a housing space that is opened at least on one side in an axis direction of the center shaft and houses at least a part of the rotating mechanism is formed between the center shaft and the rotor magnet,
the rotating mechanism includes:
an input section connected to or formed integrally with the rotor;
a fixed section connected to or formed integrally with the stator; and
an output section connected to or formed integrally with the load connecting section, and
the rotating mechanism functions as a speed-increasing gear or a reduction gear.

11. A robot comprising:
a base; and
a driving section for moving the base, wherein
the driving section includes the electric machine device according to claim 1.

12. A robot comprising:
a base; and
a driving section for moving the base, wherein
the driving section includes the electric machine device according to claim 2.

13. A robot comprising:
a base; and
a driving section for moving the base, wherein
the driving section includes the electric machine device according to claim 3.

14. A robot comprising:
a base;
a moving section that moves relatively to the base; and
a driving section that moves the moving section with respect to the base, wherein
the driving section includes the electric machine device according to claim 1.

15. A robot comprising:
a base;
a moving section that moves relatively to the base; and
a driving section that moves the moving section with respect to the base, wherein
the driving section includes the electric machine device according to claim 2.

16. A robot comprising:
a base;
a moving section that moves relatively to the base; and
a driving section that moves the moving section with respect to the base, wherein
the driving section includes the electric machine device according to claim 3.

17. A robot hand comprising:
a base;
a gripping section that is arranged on the base and grips an object; and
a driving section that drives the gripping section and causes the gripping section to grip the object, wherein
the driving section includes the actuator according to claim 7.

18. A robot hand comprising:
a base;
a gripping section that is arranged on the base and grips an object; and
a driving section that drives the gripping section and causes the gripping section to grip the object, wherein
the driving section includes the actuator according to claim 8.

19. A robot hand comprising:
a base;
a gripping section that is arranged on the base and grips an object; and
a driving section that drives the gripping section and causes the gripping section to grip the object, wherein
the driving section includes the actuator according to claim 9.
